(19) United States
(12) Patent Application Publication
(10) Pub. No.: US 2022/0219355 A1
(43) Pub. Date: Jul. 14, 2022

(54) Recycling Eutectic Composition

(71) Applicants: Novochem Green Additives 4 B.V., Houten (NL); Novochem Green Additives B.V., Houten (NL)

(72) Inventors: Erik Alexander Bijpost, Nieuwegein (NL); Alexander Maslow, Deventer (NL); Wasil Maslow, Deventer (NL)

(21) Appl. No.: 17/607,703

(22) PCT Filed: May 1, 2020
(86) PCT No.: PCT/EP2020/062188

§ 371 Date: Oct. 29, 2021

(30) Foreign Application Priority Data
May 1, 2019 (EP) 19172097.8
Nov. 12, 2019 (EP) 19020631.8

(51) Int. Cl. B29B 17/02; C08G 69/46; C08J 11/08; C08J 3/09

(52) U.S. Cl. CPC B29B 17/02; C08G 69/46; C08J 2300/30; C08J 3/096; C08J 11/08

(57) ABSTRACT

The invention pertains to a recycling composition comprising a lactam and/or a eutectic composition comprising a lactam and a eutecting agent.

The present invention relates to a recycling composition.

Recycling of plastics is currently performed mainly mechanically. The plastic materials are shredded into small pieces and separation of different plastics such as polyethylene and polyethylene terephthalate proceeds through the difference in density of the polymers. In present recycling procedures a few issues remain which determine the quality of the recycled plastics. Such issues include the presence of polyvinyl chloride labels and tackifiers or glue particles, which both lead to discoloured recycled plastics (either browning or even black spots). Also the presence of colourants (e.g. pigments and dyes) and other additives in the plastics may make it difficult to process and/or obtain high value recycled plastics. The present invention aims to overcome these issues.

The objective of the present invention is to provide novel recycling compositions.

The present invention pertains to a recycling composition comprising a lactam and/or a eutectic composition comprising a lactam and a eutecting agent. The eutecting agent is a compound capable of forming a eutectic mixture with the lactam of the invention. The lactam and the eutectic composition of the invention can dissolve (very) hydrophobic substances as well as (very) hydrophilic substances over a wide pH range. Moreover, the lactam and the eutectic composition of the invention generally have high boiling points and low volatility or vapour pressure, resulting in low or non-VOC classification. The lactam and eutectic composition of the invention, in particular when the lactam is caprolactam, generally is non-toxic and readily bio-degradable. The recycling composition of the invention can dissolve and/or penetrate a wide variety of polymers, such as polyethylene (PE), polypropylene (PP) and polyethylene terephthalate (PET), especially at elevated temperatures. In this way, additives including pigments and dyes can be dissolved together with the polymer. Upon cooling of the resulting mixture below the glass transition temperature of the polymer, the polymer will solidify with substantially less or even no additives present in the solidified polymer. Also coloured PET bottles can be recycled to clean PET without or with considerably less additives, rendering the clean PET to have a higher economical value and moreover less virgin PET is needed when recycling PET. In addition, the recycling composition of the invention is capable of delaminating laminated substrates, e.g. layered polymer substrates with different polymers, layered polymer/metal substrates and layered polymer/paper substrates, to form the individual layers. These individual layers can subsequently be separated using conventional techniques such as techniques based on the difference in density of the materials, and/or using the dissolution method as indicated above. The recycling composition of the invention is also capable of dissolving additives present in the used polymers, e.g. plasticizers and stabilizers, while maintaining the polymer in its solid state, e.g. processed at temperatures below the polymer's glass transition temperature (T_{g}). Specific embodiments of the inventive recycling composition enable the depolymerisation of the polymer, e.g. PET, to obtain considerably smaller polymer chains or even its monomers and/or oligomers. In addition, the invention further allows the removal of cured coating from substrates, e.g. aluminium or steel cans, to obtain clean metal substrates. The clean metal substrates can subsequently be re-used without the need of virgin metal material. This process has the further advantage that no (burnt) coating material is present, obviating the need for further measures to clean the metal substrate or add virgin metal material. Currently, coating removal from metal cans occurs by incineration of the coating at very high temperatures (>800° C.). With technology according to the invention, metal cans can be cleaned at much lower temperatures (below 200° C.), rendering the inventive process to be conducted with significantly lower energy consumption.

The recycling composition may comprise solely of lactam and/or eutectic composition comprising lactam and a eutecting agent. The composition of the invention comprises the lactam and/or eutectic composition in an amount of 100% by weight (wt %), based on the total weight of the recycling composition. Preferably, the lactam and/or eutectic composition is present in an amount of at most 99 wt %, more preferably at most 98 wt %, even more preferably at most 95 wt %, even more preferably at most 90 wt %, even more preferably at most 85 wt % and even most preferably at most 80 wt %, and preferably at least 1 wt %, more preferably at least 2 wt %, even more preferably at least 5 wt %, even more preferably at least 10 wt %, even more preferably at least 15 wt % and most preferably at least 20 wt %, based on the total weight of the recycling composition.

In yet a further embodiment, the eutectic composition of the invention may be a strong eutectic composition, i.e. can be distilled and forming a eutectic distillate. Without being bound by theory, this means that the association between the lactam and the eutecting agent remains intact while being evaporated during distillation, and upon cooling of the distilled vapour the eutectic composition is obtained. These eutectic compositions are referred to as “strong eutectic compositions”. Such strong eutectic compositions will maintain its composition both in the original eutectic composition as well as in the distillate. In contrast, eutectic compositions from which one of the components will be distilled off separately are referred to as “weak eutectic compositions”. In such a case, the lactam, which generally has a higher boiling point than the eutecting agent, may solidify upon cooling or during distillation. In some instances, no eutectic composition is formed but instead a solution of lactam in a liquid agent is obtained. In such case, the liquid agent is also distilled off separately.

The lactam of the invention is well known in the art and refers to a cyclic amide. Typically and preferably, the lactam is not substituted on the nitrogen in the ring. Most preferably, the lactam is not substituted. Examples of lactams include β-lactam, γ-lactam, δ-lactam and ε-lactam. The lactam may be substituted, e.g. with C₁-C₄ alkyl or vinyl, or unsubstituted. Unsubstituted lactams are preferred. Examples of unsubstituted lactams include 2-azetidinone, γ-butyrolactam, 2-piperidinone (or 6-valerolactam), ε-Caprolactam and caprylolactam. Preferably, the lactam is selected from γ-butyrolactam and ε-caprolactam. Most preferably, the lactam is ε-Caprolactam. It is contemplated that two or more lactams are used in the eutectic composition of the invention.

The lactam may also be an oligomer of the lactam, preferably the oligomer is a cyclic oligomer. The oligomer can be a dimer, trimer, tetramer, pentamer of hexamer of lactam. Examples of the oligomers of lactam can be found in Abe et al. (Abe, Y. et al (2016) Isolation and Quantification of Polyamide Cyclic Oligomers in Kitchen Utensils and Their Migration into various Food Stimulants, PLoS ONE 11(7): e0159547, doi:10.1371/journal.pone.0159547). Preferably, the oligomer is a dimer of lactam, even more preferably the dimer is a dimer of caprolactam, preferably 1,8-diaxacyclodecane-2,9-dione.

In a further preferred embodiment, the lactam of the invention is a combination of γ-butyrolactam and ε-Caprolactam. The invention encompasses a eutectic composition comprising γ-butyrolactam and ε-Caprolactam, as well as a eutectic composition comprising γ-butyrolactam and ε-Caprolactam and a eutecting agent. In one embodiment, the eutectic composition comprises γ-butyrolactam and ε-caprolactam. In either the eutectic composition or the lactam combination, the molar ratio between γ-butyrolactam and ε-caprolactam is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, even more preferably at most 40, even more preferably at most 20, even more preferably at most 10 and most preferably at most 5.

The composition of the invention may comprise a eutectic composition comprising a lactam and a eutecting agent. The lactam may be the lactam as indicated above. The eutectic composition of the invention comprises the lactam in an amount of at most 90% by weight (wt %), based on the total weight of the eutectic composition. Preferably, the lactam is present in an amount of at most 85 wt %, more preferably at most 80 wt %, even more preferably at most 70 wt %, even more preferably at most 60 wt %, even more preferably at most 50 wt % and even most preferably at most 40 wt %, and preferably at least 1 wt %, more preferably at least 2 wt %, even more preferably at least 5 wt %, even more preferably at least 10 wt %, even more preferably at least 15 wt % and most preferably at least 20 wt %, based on the total weight of the eutectic composition.

The eutecting agent in the eutectic composition of the invention can be any eutecting agent capable of forming a eutectic mixture with the lactams. Typically, the eutecting agent has an ionic part. The ionic part can be cationic, anionic or amphiphilic, preferably the ionic part is amphiphilic. The eutecting agent can be a hydrogen-bond donor, an electron pair donor, hydrogen-bond acceptor, an electron pair acceptor or a metal salt. In one embodiment, the eutecting agent is a hydrogen-bond donor or acceptor comprising a functional group selected from, but not limited to, acids, anhydrides, amines, amides, imides, alcohols, quaternary ammonium salts. Preferably, the eutecting agent is selected from the group consisting of cyclic acids, aliphatic acids, cyclic acid anhydrides, aliphatic acid anhydrides, amines, amides, imides and alcohols. Most preferably, the eutecting agent is selected from the group consisting of cyclic acids and cyclic anhydrides. In the context of the present description, the term “cyclic acid” refers to a ring-containing molecule comprising an acid group; the ring can be a phenyl group or a cycloalkyl group, for example and the acid group can be a carboxylic acid or a sulphonic acid group, for instance.

In a preferred embodiment, the eutecting agent comprises at least 2 functional groups. The functional groups may be the same or different. The advantage of a eutecting agent having at least two functional groups is that the resulting eutecting composition when combined with the lactam of the invention is more stable and less dependent on pH, temperature and/or concentration. Preferably, the eutecting agent comprises at least 2 functional groups in which at least two functional groups are separated by at most 3 atoms, preferably at most 2 atoms. Preferably, the polyfunctional compound comprises at least one of the substituents selected from the group consisting of carboxylic acid and ether. The other group(s) may be any known functional group.

In a preferred embodiment, the eutecting agent comprises at least 3 carbon atoms, and preferably at least 4 carbon atoms. The eutecting agent can be a monomer, an oligomer or a polymer.

In one embodiment, the eutecting agent is an oligomer or polymer having a plurality of functional groups. When a molar ratio is indicated and it relates to an oligomer or polymer, the molar ratio should be calculated based on the number of monomers present in the oligomer or polymer. In other words, a polymer comprising 500 monomer units should be contacted with 500 lactam molecules to reach a molar ratio between polymer and lactam of 1 or 1:1. This is different from the molar ratio or 1:1 molar complexes as disclosed in U.S. Pat. No. 4,319,881, which refers to a molar ratio of 1 molecule of lactam per polyethylene glycol oligomer (e.g. PEG 300). At such molar ratios, a eutectic composition is not obtained.

Examples of suitable acids include aliphatic monoacids such as formic acid, acetic acid, lactic acid and butyric acid; aliphatic polyacids such as oxalic acid, citric acid, citraconic acid and maleic acid; and cyclic acids such as salicylic acid, 2-phenol phosphinic acid, 2-phenol phosphonic acid and 2-phenol sulphonic acid. Preferably, the acid is an aliphatic acid, more preferably the acid is lactic acid. Preferably, the acid is a cyclic acid, more preferably the acid is salicylic acid. In one embodiment of the invention, the eutectic agent is an acid having a pKa (i.e. the acid dissociation constant) of at most 6, preferably a pKa of at most 5, and more preferably a pKa of at most 4, even more preferably a pKa of at most 3.5 and most preferably a pKa value of at most 3, and preferably a pKa of at least 0, more preferably a pKa of at least 0.5 and most preferably a pKa of at least 1.

Examples of suitable acid anhydrides include aliphatic acid anhydrides such as formic anhydride, acetic anhydride, propanoic anhydride, butyric anhydride, crotonic anhydride and benzoic anhydride; and cyclic acid anhydrides such as maleic anhydride, citraconic anhydride, itaconic anhydride, phthalic anhydride, trimellitic anhydride, hexahydrophthalic anhydride, methyl hexahydrophthalic anhydride, tetrahydrophthalic anhydride, methyl tetrahydrophthalic anhydride, tetrachlorophthalic anhydride, pyromellitic dianhydride, himic anhydride, succinic anhydride, dodecenylsuccinic anhydride, chlorendic anhydride and tetrabromophthalic anhydride. Preferably, the acid anhydride is a cyclic acid anhydride. More preferably, the cyclic acid anhydride is selected from the group consisting of maleic anhydride, citraconic anhydride, itaconic anhydride and phthalic anhydride, even more preferably the cyclic acid anhydride is maleic anhydride or citraconic anhydride, and most preferably, the acid anhydride is maleic anhydride. The advantage of maleic anhydride and citraconic anhydride is their potential to react with water, oxygen and radicals. These anhydrides are further advantageous in ternary or quaternary eutectic compositions to reduce the viscosity of the resulting eutectic composition. Especially when a solute is dissolved in the eutectic composition of the invention its viscosity may increase at higher solute concentrations—which tend to be higher than the solubility in conventional solvents—the cyclic anhydride, and in particular maleic anhydride and/or citraconic anhydride, significantly reduces the viscosity of the eutectic composition.

Examples of suitable ethers include monomeric ethers such as methyl ethyl ether, methyl phenyl ether, diethylene glycol, triethylene glycol, dibutyl ether, and dihexyl ether; and polyethers such as paraformaldehyde, polyethylene glycol (PEG), polypropylene glycol (PPG), polytetramethylene glycol (PTMG), polytetramethylene ether glycol (PTMEG), polytatrahydrofuran (PTHF), polyoxymethylene (POM), polyethylene oxide (PEO), polypropylene oxide (PPDX) and polyethyleneglycol-polypropyleneglycol (EO/PO block copolymers). Aromatic ethers, such as phenolic and benzylic ethers, are also suitable.

Examples of polysaccharides include celluloses such as cellulose, methyl cellulose (MC), ethyl cellulose (EC), hydroxyethyl cellulose (HEC), ethyl hydroxyethyl cellulose (EHEC), methyl ethyl hydroxyethyl cellulose (MEHEC), carboxymethyl cellulose (CMC), hydroxypropyl methyl cellulose (HPMC); and starches such as starch, oxidized starch, hydroxyethyl starch, hydroxypropyl starch and carboxymethyl starch; chitin and arabinoxylans. The polysaccharide can have any degree of polymerization (DP) and degree of substitution (DS) known in the art.

Examples of functionalized polymers include polyvinyl alcohol (PVA), polyvinyl acetate, polyvinylbutyral (PVB), polyvinylamine, polyvinylamides, polyurethanes, polyamides, polyimides, polycarbonates, polyesters, poly lactic acid (PLA), poly(lactic-co-glycolic acid) (PLGA), and polyvinyl pyrrolidone (PVP).

Examples of suitable amines include aliphatic polyamines include EDA homologues such as linear, branched and cyclic EDA homologues including tetraethylene pentamine (TEPA), triethylene tetramine (TETA), diethylene triamine (DETA), hexaethylene pentamine (HEPA) and N-aminoethyl piperazine (NAEP); propylene homologues such as dipropylene triamine (DPTA; methylene homologues such as hexamethylene pentamine (HMPA); polyether monoamines such as Jeffamine® M-600 amine, Jeffamine® M-1000 amine, Jeffamine® M-2005 amine and Jeffamine® M-2070 amine; polyether diamines such as Jeffamine® D-230 amine, Jeffamine® D-2300 amine, Jeffamine® D-400 amine, Jeffamine® D-4000 amine, Jeffamine® ED-600 amine, Jeffamine®ED-900 amine, Jeffamine®ED-2003 amine, Jeffamine® EDR-148 amine and Jeffamine® EDR-176 amine; polyether triamines such as Jeffamine®T-403 amine, Jeffamine®T-3000 amine and Jeffamine®T-5000 amine; alkylated polyamines include propylene diamines such as coco propylene diamine, oleyl propylene diamine, arachidyl behenyl propylene diamine, soya propylene diamine, (partially) hydrogenated tallow propylene diamine, N,N,N′-trimethyl-N′-tallow propylene diamine and tallow propylene diamine; dipropylene triamines such as dodecyl dipropylene triamine, oleyl dipropylene triamine, octyl dipropylene triamine, stearyl dipropylene triamine and tallow dipropylene triamine and other polyamines such as N-tallowalkyl dipropylene tetramine, N-tallowalkyl tripropylene triamine, N-(3-aminopropyl)-N-cocoalkyl propylene diamine, N-(3-aminopropyl)-N-tallowalkyl propylene diamine, N-(3-aminopropyl)-N-cocoalkyl trimethylenediamine, N-(3-aminopropyl)-N-tallowalkyl trimethylenediamine and dendrimers containing propylene diamines; bisalkylated amines such as di(dodecyl) amine, di(oleyl) amine, di(arachidyl behenyl) amine, di(tallow) amine, di(octyl) amine, di(stearyl) amine and di(coco) amine; alkylated primary amines such as dodecyl amine, oleyl amine, hexadecyl amine, arachidyl behenyl amine, hydrogenated tallowalkyl amine, tallowalkyl amine, rapeseedalkyl amine, hydrogenated rapeseedalkyl amine, soyaalkyl amine, octyl amine, octadecyl amine, stearyl amine, coco amine and polyvinyl amine; alkoxylated polyamines such as propylene diamines such as octyl/decyloxypropyl-1,3-diaminopropane, isodecyloxypropyl-1,3-diaminopropane, isododecyloxypropyl-1,3-diaminopropane, dodecyl/tetradecyloxypropyl-1,3-diaminopropane, isotridecyloxypropyl-1,3-diaminopropane and tetradecyloxypropyl-1,3-diaminopropane; and dipropylene triamines such as dodecyl dipropylene triamine, dodecyl dipropylene triamine, octyl/decyl dipropylene triamine, isotridecyl dipropylene triamine and tetradecyl dipropylene triamine; bisalkoxylated amines such as di(dodecyloxypropyl) amine, di(oleyloxypropyl) amine, di(arachidyl behenyloxypropyl) amine, di(tallowoxypropyl) amine, di(octyloxypropyl) amine, di(stearyloxypropyl) amine and di(cocoalkyloxy) amine; and alkoxylated amines such as isopropyloxypropyl amine, hexyloxypropyl amine, 2-ethylhexyloxypropyl amine, octyl/decyloxypropyl amine, isodecyloxypropyl amine, dodecyl/tetradecyloxypropyl amine, isotridecyloxypropyl amine, tetradecyloxypropyl amine, tetradecyl/dodecyloxypropyl amine, linear alkyloxypropyl amine and octadecyl/hexadecyloxypropyl amine.

Examples of suitable amides include aliphatic unsubstituted amides such as urea, formamide, acetamide, propanamide, butanamide, pentanamide, hexanamide and heptanamide; substituted aliphatic amides such as N-methylpropanamide, N-ethylpropanamide, N-methylbutanamide, N-ethylbutanamide, N-acetyl-3-oxopentanamide, N-acetyl butanamide, N-acetyl propanamide, N-Acetyl-2-amino-5-(diaminomethylideneamino) pentanamide, N-acetyl benzamide, N-methylpentanamide, N-ethylpentanamide; aromatic amides such as benzamide, ethenzamide and salicylamide.

Examples of suitable imides include aliphatic imides such as trifluoromethylsulfonyl imide, pentafluoroethylsulfonyl imide, methylsulfonyl imide and ethylsulfonyl imide; cyclic imides such as succinimide, maleimide, citraconimide, glutarimide, phthalimide, tetrahydrophthalimide, hexahydrophthalimide, pyromellitic diimide, 1,8-naphthalimide, cyclohexane-1,2-dicarboximide and 1,3-bis(citraconimidomethyl) benzene (Perkalink®900). Preferably, the imide is 1,3-bis(citraconimidomethyl) benzene.

Examples of suitable alcohols include aliphatic polyols such as 1,2-ethanediol, 1,3-propanediol, 1,4-butanediol, glycerol, ethylene glycol, propylene glycol, mannitol and trimethylol propane (TMP); and cyclic alcohols such as ascorbic acid, glucuronic acid, catechol and salicylic acid; monosaccharides such as glucose, altrose, fructose, mannose, iodose, talose, allose, gulose, galactose, ribose, arabinose, xylose, lyxose and glucosamine; and disaccharides such as sucrose, lactose, lactulose, trehalose, cellobiose and chitobiose.

The eutectic composition of the invention comprises the eutecting agent in an amount of at least 10% by weight (wt %), based on the total weight of the eutectic composition. Preferably, the lactam is present in an amount of at least 15 wt %, more preferably at least 80 wt %, even more preferably at least 30 wt %, even more preferably at least 40 wt %, even more preferably at least 50 wt % and even most preferably at least 60 wt %, and preferably at most 99 wt %, more preferably at most 98 wt %, even more preferably at most 95 wt %, even more preferably at most 90 wt %, even more preferably at most 85 wt % and most preferably at most 80 wt %, based on the total weight of the eutectic composition.

The molar ratio between lactam and the eutecting agent is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, even more preferably at most 40, even more preferably at most 20, even more preferably at most 10 and most preferably at most 5.

When the lactam is a combination of 2 or more lactams, the molar ratio between lactam and the eutecting agent is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, and most preferably at most 40.

In one embodiment, the recycling composition of the invention further comprises water. Water may form a eutectic composition with the lactam. Water may also form ternary, quaternary of higher eutectic compositions with one or more lactams and one or more eutecting agents. The presence of water may increase the ability of the resulting eutectic composition to dissolve hydrophobic and/or hydrophilic components. Water may further reduce the viscosity of the recycling composition. Moreover, a (further) decrease of the melting temperature of the recycling composition and/or eutectic composition is generally observed.

The molar ratio between lactam and water is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, and most preferably at most 40.

The molar ratio between the eutecting agent and water is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, and most preferably at most 40.

When the lactam is a combination of 2 or more lactams, the molar ratio between lactam and water is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, and most preferably at most 40.

When the lactam is a combination of 2 or more lactams, the molar ratio between the eutecting agent and water is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, and most preferably at most 40.

In one embodiment of the invention, the eutecting agent is water. In a further embodiment, the eutectic composition comprises a lactam and water. The lactam may be the same as indicated above. The inventors have surprisingly found that lactam and water can form a eutectic composition, which results in a lowering of the melting temperature of the resulting eutectic composition compared to the individual melting points of the lactam and water. Eutectic compositions of lactam and water were observed to be liquid at temperatures below 0° C., even as low as −10° C. These eutectic compositions are able to dissolve both hydrophilic and hydrophobic components. The advantages mentioned for eutectic compositions comprising lactam and a eutecting agent generally also apply to the eutectic compositions comprising lactam and water.

The molar ratio between lactam and water is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, even more preferably at most 40, even more preferably at most 20, even more preferably at most 10 and most preferably at most 5.

The eutectic composition of the invention comprises the lactam in an amount of at most 90% by weight (wt %), based on the total weight of the eutectic composition. Preferably, the lactam is present in an amount of at most 85 wt %, more preferably at most 80 wt %, even more preferably at most 75 wt %, even more preferably at most 70 wt %, even more preferably at most 60 wt % and even most preferably at most 50 wt %, and preferably at least 1 wt %, more preferably at least 2 wt %, even more preferably at least 5 wt %, even more preferably at least 10 wt %, even more preferably at least 15 wt %, even more preferably at least 20 wt % and most preferably at least 25 wt %, based on the total weight of the eutectic composition. In a preferred embodiment, the eutectic composition of the invention comprises water in an amount of at least 15 wt % and at most 75 wt %. These eutectic compositions generally have a lower melting point than eutectic compositions comprising water amounts outside of the indicated range. Also with amounts below 15 wt %, the lactam, such as ε-caprolactam, may at least partially solidify at temperatures below 0° C. Also amounts of water above 75 wt % may cause freezing of the water in the composition at temperatures below 0° C.

The eutectic composition of the invention comprises water in an amount of at least 10% by weight (wt %), based on the total weight of the eutectic composition. Preferably, water is present in an amount of at least 15 wt %, more preferably at least 20 wt %, even more preferably at least 25 wt %, even more preferably at least 30 wt %, even more preferably at least 40 wt % and even most preferably at least 50 wt %, and preferably at most 99 wt %, more preferably at most 98 wt %, even more preferably at most 95 wt %, even more preferably at most 90 wt %, even more preferably at most 85 wt %, even more preferably at most 80 wt % and most preferably at most 75 wt %, based on the total weight of the eutectic composition.

In one embodiment, the eutectic composition of the invention further comprises a second eutecting agent. The second eutecting agent may be the same as the eutecting agent indicated above.

In a further embodiment, the eutectic composition of the invention comprises the second eutecting agent in an amount of at most 85% by weight (wt %), based on the total weight of the eutectic composition. Preferably, the eutecting agent is present in an amount of at most 70 wt %, more preferably at most 60 wt %, even more preferably at most 50 wt %, even more preferably at most 40 wt % and most preferably at most 30 wt %, and preferably at least 1 wt %, more preferably at least 2 wt %, even more preferably at least 5 wt % and most preferably at least 10 wt %, based on the total weight of the eutectic composition.

In one embodiment, the eutectic composition further comprises a hydroxide salt. Examples of such hydroxide salts include alkali metal hydroxides such as potassium hydroxide and sodium hydroxide. Of these hydroxide salts potassium hydroxide and sodium hydroxide are preferred. The addition of such hydroxide salts generally causes the lactam to be converted into lactamate. Such lactamates generally have all the advantages the lactam has in the eutectic compositions of the invention. The compositions comprising the lactamate generally have an improved conductivity, an improved cleaning power and an ability to bind with cations, in particular metal ions. In the cleaning of polymers such as PET the contaminants are generally removed easier and faster, while the properties of PET or the polymer does not change. In conventional processes where a hydroxide salt is used, the polymer in particular PET is at least partially hydrolysed, rendering the quality of the polymer to be lower and the number of recycling cycles to be limited.

The eutectic composition of the invention comprises the hydroxide salt in an amount of at most 90% by weight (wt %), based on the total weight of the eutectic composition. Preferably, the hydroxide salt is present in an amount of at most 85 wt %, more preferably at most 80 wt %, even more preferably at most 75 wt %, even more preferably at most 70 wt %, even more preferably at most 60 wt % and even most preferably at most 50 wt %, and preferably at least 1 wt %, more preferably at least 2 wt %, even more preferably at least 5 wt %, even more preferably at least 10 wt %, even more preferably at least 15 wt %, even more preferably at least 20 wt % and most preferably at least 25 wt %, based on the total weight of the eutectic composition.

The molar ratio between lactam and hydroxide salt is at least 0.01. Preferably, the ratio is at least 0.05, more preferably at least 0.1, even more preferably at least 0.2, even more preferably at least 0.5, and most preferably at least 1, and preferably at most 100, more preferably at most 75, even more preferably at most 50, even more preferably at most 40, even more preferably at most 20, even more preferably at most 10 and most preferably at most 5. For applications where a surplus of hydroxide or more alkaline conditions are not preferred, the molar ratio between lactam and hydroxide salt should be at least 1. In this way, the hydroxide is completely consumed by the lactam and no or a small amount of residual hydroxide remains in the eutectic composition.

In one embodiment, the recycling composition of the invention further comprises a solvent. The additional solvent can be any solvent known in the art, which can be suitably used in recycling compositions. The composition of the invention may exhibit improved cleaning properties, e.g. faster cleaning and more thorough cleaning, when the solvent is present. Examples of such solvents include water; primary monoalcohols such as methanol, ethanol, 1-propanol, 2-butoxy ethanol, 2-hexoxy ethanol and benzyl alcohol; secondary alcohols such as isopropyl alcohol and 2-butanol; primary polyols such as 3-methyl-1,5-pentanediol, trimethylol propane, triethanolamine, ethylene glycol, propylene glycol, polyethylene glycol, polypropylene glycol and glycerol; carboxylic esters such as ethyl lactate and butyl lactate; primary amines such as urea, triethanolamine; cyclic anhydrides such as citraconic acid anhydride, maleic acid anhydride and itaconic acid anhydride; and phenyl-containing compounds such as styrene, a-methylstyrene and salicylic acid. Preferably, the solvent is a primary monoalcohol or a carboxylic ester. More preferably, the solvent is selected from the group consisting of methanol, ethanol, 1-propanol, 2-butoxy ethanol, 2-hexoxy ethanol, ethyl lactate, butyl lactate and benzyl alcohol. Even more preferably, the solvent is selected from the group consisting of ethanol, 2-butoxy ethanol, 2-hexoxy ethanol, ethyl lactate and benzyl alcohol.

In a further embodiment, the recycling composition of the invention comprises the solvent in an amount of at most 30% by weight (wt %), based on the total weight of the cosmetic cleaning composition. Preferably, the solvent is present in an amount of at most 25 wt %, more preferably at most 20 wt %, even more preferably at most 15 wt %, even more preferably at most 10 wt % and most preferably at most 5 wt %, and preferably at least 0.1 wt %, more preferably at least 0.2 wt %, even more preferably at least 0.5 wt % and most preferably at least 1 wt %, based on the total weight of the recycling composition.

The composition of the invention may further comprise a recycling excipient. Such additives may be any recycling excipient known in the art and which can be suitably used in recycling compositions. Such excipients include surfactants, antifoaming agents, buffers, acids and bases, e.g. aqueous potassium hydroxide or sodium hydroxide solutions.

In a further embodiment, the recycling composition of the invention comprises the recycling excipient in an amount of at most 30% by weight (wt %), based on the total weight of the recycling composition. Preferably, the recycling excipient is present in an amount of at most 25 wt %, more preferably at most 20 wt %, even more preferably at most 15 wt %, even more preferably at most 10 wt % and most preferably at most 5 wt %, and preferably at least 0.1 wt %, more preferably at least 0.2 wt %, even more preferably at least 0.5 wt % and most preferably at least 1 wt %, based on the total weight of the recycling composition.

The remaining part of the recycling composition may be comprised of other components commonly or not commonly used in recycling composition. With the lactam, the eutecting agent and the solvent, the other components add up to 100 wt % of the total weight of the recycling composition.

Recycling Used Polymers

The invention further pertains to a process for recycling of used polymer comprising the steps of:

(a) contacting the used polymer with a recycling composition comprising a lactam and/or a eutectic composition comprising a lactam and a eutecting agent;

(b) optionally shredding the used polymer before, during and/or after step (a);

(c) optionally increasing the temperature of the mixture;

(d) separating the recycling composition comprising at least part of the additives present in the used polymer from the used polymer; and

(e) cooling the recycling composition and/or the used polymer before, during and/or after step (d). The process of the invention allows for the separation of additives, such as pigments and dyes and other excipients, present in used polymer from the polymer itself. In this way, clean polymer is obtained which contains considerably less or even no additives. These recycled polymers do not need to be diluted with virgin polymer or can be diluted with far less virgin polymer. The commercial value of the polymers obtained with the inventive process is higher than the value of the currently recycled plastics. Moreover, the variety of possible uses increases compared to the currently recycled plastics.

In one embodiment, the additives are pigments and/or dyes. At relatively low temperatures even at room temperature, pigments and/or dyes may be removed from the used polymer, thereby discoloring the used polymer.

In the context of the present application the term “used polymer” or “used plastics” refer to plastic material that has been used and served their purpose. This plastic material can be returned after use (e.g. plastic bottles) or can be found in collected garbage (e.g. packaging). With “virgin plastic” or “virgin polymer” is meant polymers that have been produced from their monomers (e.g. originating from petrochemical feedstock such as crude oil or gas), that have never been processed before and are to be used in their application for the first time. The used polymers suitable for the process of the invention can be any polymer known in the art that is eligible for recycling. The polymer can be a homopolymer (made up of one monomer), a heteropolymer/copolymer (made up of two or more monomers) or a block copolymer (made up of two or more different polymeric units). Examples of suitable polymers are polyolefins, such as polyethylene and polypropylene as well as grafted polyolefins; vinyl polymers, such as polystyrene, polymethyl methacrylate, polyvinyl chloride, polyvinylidene chloride or polyvinylidene fluoride, and blends of two or more polymers. Preferred polymers are polyolefins, vinyl polymers, polyesters, polycarbonates, polyamides, polyurethanes, polyepoxides, polyvinylalcohol, polyvinylbutyral, polyvinylacetaat, polyethers, polythioethers or polytetrafluoro ethylene (Teflon®).

In a further embodiment of the invention, the polymer is a thermoplastic polymer. Examples of thermoplastic polymers include polyethylene, polypropylene, grafted polyolefins, and polystyrene; polyesters such as polyethylene terephthalate (PET), polyethylene furanoate (PEF), polybutylene terephthalate (PBT), polytrimethylene terephthalate (PTT) and polyethylene naphthalate (PEN); biodegradable polyesters such as polylactic acid (PLA), polyglycolic acid (PGA) and poly(glycolide-co-lactide) (PGLA); polyamides such as nylon 6, nylon 1,6 and nylon 6,6; acetal (co)polymers, such as polyoxymethylene (POM); rubbers, such as natural rubber (NR), styrene-butadiene rubber (SBR), polyisoprene (IR), polybutadiene (BR), polyisobutylene (IIR), halogenated polyisobutylene, butadiene nitrile rubber (NBR), hydrogenated butadiene nitril (HNBR), styrene-isoprene-styrene (SIS) and similar styrenic block copolymers, poly(epichlorohydrin) rubbers (CO, ECO, GPO), silicon rubbers (Q), chloroprene rubber (CR), ethylene propylene rubber (EPM), ethylene propylene diene rubber (EPDM), polysulfide rubber (T), fluorine rubbers (FKM), ethane-vinylacetate rubber (EVA), polyacrylic rubbers (ACM), polynorbornene (PNR); polyurethanes (AU/EU) and polyester/ether thermoplastic elastomers. Preferred polymers are polyolefins, polyesters and biodegradable polyesters. More preferred are polyethylene, polypropylene, and polyethylene terephthalate.

Particularly preferred are polymers or copolymers obtained by polymerization of at least one ethylenically unsaturated monomer. Such polymers include polyolefins and modified polyolefins, which are known to the man skilled-in-the-art. The polyolefin or modified polyolefin can be a homopolymer or a copolymer, terpolymer of grafted polymer. Examples of such (modified) polyolefins include polyethylene, polypropylene, polybutylene, polystyrene, polyvinyl chloride, polyvinylidene chloride and ethylene-propylene rubber, propylene-butene copolymer, ethylene-vinyl chloride copolymer, ethylene-vinyl acetate copolymer, acrylonitrile-butadiene-styrene copolymer (ABS), acrylonitrile-acrylate-styrene copolymer (AAS), methyl methacrylate-butadiene-styrene copolymer (MBS), chlorinated polyethylene, chlorinated polypropylene, ethylene-acrylate copolymer, vinyl chloride-propylene copolymer, maleic anhydride-grafted polyolefin, maleic acid-grafted polyolefin, and mixtures thereof. More preferred polyolefins are polyethylene, polypropylene, polystyrene and polyvinyl chloride.

Suitable examples of polyethylene are high-density polyethylene (HDPE), low-density polyethylene (LOPE), straight chain low-density polyethylene (LLDPE), ultra-low density polyethylene and ultra-high molecular weight polyethylene. Further examples of ethylene-based copolymers include ethylene-vinyl acetate copolymer (EVA), ethylene-ethyl acetate copolymer (EEA), ethylene-methyl acrylate copolymer (EMA) and ethylene-acrylic acid copolymer (EAA).

In one embodiment of the invention, the used polymer is used in the process in an amount of at least 10% by weight (wt %), based on the total weight of used polymer and recycling composition. Preferably, the polymer is present in an amount of at least 20 wt %, more preferably at least 30 wt %, even more preferably at least 35 wt % and most preferably at least 40 wt %, and preferably at most 99 wt %, more preferably at most 95 wt %, even more preferably at most 90 wt %, even more preferably at most 85 wt %, even more preferably at most 80 wt %, and most preferably at most 75 wt %, based on the total weight of used polymer and recycling composition.

The used polymer of the invention may comprise additives commonly used in polymer-containing compositions including pigments and dyes, heat stabilizers, anti-oxidants, fillers, such as hydroxyapatite, silica, carbon black, glass fibers and other inorganic materials, flame retardants ,nucleating agents, impact modifiers, plasticizers, rheology modifiers, cross-linking agents, anti-gassing agents, surfactants, flow controlling agents, ultraviolet light (UV) stabilizers, adhesion enhancing promoters, waxes, matting agents, defoamers and curing catalysts. Examples of pigments and dyes include metal oxides like iron oxide, zinc oxide and; metal hydroxides; metal sulfides, metal sulfates, metal carbonates, such as calcium carbonate; carbon black, china clay, phthalo blues and greens, organo reds and other organic dyes.

The additives are optional and can be chosen according to need in amounts as desired. The used polymer of the invention may comprise the additives in an amount of at most 30% by weight (wt %), based on the total weight of the used polymer. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the used polymer.

The remaining part of the used polymer may be comprised of other components commonly used in polymers. With the polymer and the additives, the other components add up to 100 wt % of the total weight of the used polymer.

The recycling composition can be any composition described above. In one embodiment of the invention, the recycling composition is used in the process in an amount of at most 90% by weight (wt %), based on the total weight of used polymer and recycling composition. Preferably, the recycling composition is present in an amount of at most 80 wt %, more preferably at most 70 wt %, even more preferably at most 65 wt % and most preferably at most 60 wt %, and preferably at least 1 wt %, more preferably at least 5 wt %, even more preferably at least 10 wt %, even more preferably at least 15 wt %, even more preferably at least 20 wt %, and most preferably at least 25 wt %, based on the total weight of used polymer and recycling composition.

In step (a) of the process of the invention the used polymer and the recycling composition are contacted to obtain a mixture. The recycling composition can be mixed with the used polymer in one go, or intermittently in multiple portions. Alternatively, the used polymer can be mixed with the recycling composition in one go, or intermittently in multiple portions. Preferably, the used polymer and the recycling composition are mixed while the mixture is stirred mechanically. The process of the invention comprises the step of optionally shredding the used polymer before, during and/or after step (a). The term “shredding” refers to the mechanical comminution of the used polymer into small(er) pieces (e.g. cm-size pieces). Such a shredding process is well known in the art, and is already used on commercial scale in current recycling procedures. Upon shredding of the used polymer, the shredded polymer pieces can be more easily accessed by the recycling composition, and additives can be more effectively removed from the used polymer. Also the dissolution rate of the used polymer may improve. Step (b) of the process may increase the speed of the process and hence may shorten the recycling processing time. The shredding step may be performed before contacting the used polymer with the recycling composition. It is also envisaged that first the used polymer is contacted with a part of the recycling composition before commencing with the shredding step, after which the rest of the recycling composition is added. Also the shredding step (b) may be performed after the recycling composition is mixed with the used polymer.

The process of the invention comprises the step of optionally increasing the temperature of the mixture of used polymer and recycling composition obtained in steps (a) or (b). The temperature of the mixture may be increased to a temperature below the glass temperature of the used polymer. At this temperature the additives generally dissolve more rapidly while maintaining the polymer in its solid form. The temperature may also be increased to above the temperature at which the polymer per se dissolves. Preferably, the temperature of step (c) is increased to above the glass temperature of the polymer. In one embodiment, the temperature of the mixture is at least 20° C., preferably at least 30° C., more preferably at least 40° C., even more preferably at least 50° C., even more preferably at least 80° C. and most preferably at least 100° C., and preferably at most 230° C., more preferably at most 200° C., even more preferably at most 180° C. and most preferably at most 150° C.

In step (d) of the process of the invention, the recycling composition comprising at least part of the additives present in the used polymer is separated from the used polymer. When the used polymer is exposed to the recycling composition, additives like pigments and dyes can be extracted from the used polymer and dissolved in the recycling composition. The liquid can be separated from the solid used polymer using conventional separation techniques well known to the skilled person, such as decanting or filtering. When the temperature is increased to above the glass transition temperature of the polymer, the polymer is generally also dissolved in the recycling composition. The polymer can then be separated by lowering the temperature to below the glass transition temperature until the polymer solidifies (and preferably above the temperature at which any one of the additives deposits), and subsequently removing the liquid comprising the additives dissolved therein from the solidified polymer with known separation techniques. Preferably, the temperature of step (e) is decreased to below the glass temperature of the polymer. In one embodiment, the temperature of the mixture is at most 80° C., preferably at most 70° C., more preferably at most 60° C., even more preferably at most 50° C., even more preferably at most 40° C. and most preferably at most 30° C., and preferably at least 0° C., more preferably at least 5° C., even more preferably at least 10° C. and most preferably at least 15° C.

In a further step of the process, the additives can be obtained using conventional separation techniques. Lowering the temperature to below 0° C. (or even lower temperatures) enables deposition of some or all of the additives. The additives may be re-used in polymer materials or any other suitable use. Additionally, the recycling composition can be re-used in the process of the invention.

The invention further pertains to the recycled polymer obtained with the process of the invention.

Delaminating a Laminated Substrate

The invention further pertains to a process for delaminating at least one polymer layer from a laminated substrate comprising the steps of:

(a) contacting the laminated substrate with a recycling composition comprising a lactam and/or a eutectic composition comprising a lactam and a eutecting agent;

(b) optionally shredding the laminated substrate before, during and/or after step (a);

(c) optionally increasing the temperature of the mixture;

(d) separating the at least one polymer layer from the substrate;

(e) optionally separating the recycling composition comprising at least part the polymer and/or the additives present in the laminated substrate from the substrate; and

(f) cooling the recycling composition and/or the substrate before, during and/or after step (d).

The recycling composition of the invention is capable of delaminating a laminated substrate, therewith obtaining separate, individual layers which are not connected anymore. With “laminated substrate” is meant a material comprising at least two layers of different material, and of which at least one layer is a polymer layer. The laminated substrate may comprise of three or four layers and even can contain 1000 layers. The laminated substrate may have multiple layers of two or more different materials. The laminated substrate may comprise two or more polymer layers that are enjoining layers one stacked on the other. Examples of such laminated substrates include bottles, food packaging, medical packaging, trash bags and blood bags. The laminated substrate may also comprise at least one metal layer and at least one polymer layer. Examples of such laminated substrate comprising a metal layer include metal-polymer laminates, food packaging and automotive plating material. The laminated substrate may further comprise at least one layer of paper and at least one polymer layer. Examples of such laminated substrates include corrugated fiberboard, laminated paper and drink and food packaging. In the context of the present application, the wording “delaminate” or “delaminating” refers to the process of splitting enjoining layers in a laminated substrate. With the process of the invention, polymer layers can be readily removed from laminated substrates without leaving any polymer material and/or glue onto the substrate. From a laminated substrate comprising an aluminium sheet and a polymer layer that is exposed to the process of the invention, the polymer layer can be released and a clean aluminium sheet is left. This clean aluminium sheet can be re-used. Also the polymer layer can be obtained that can be re-used.

The polymer layer in the laminated substrate suitable for the process of the invention can be made of any polymer known in the art that is eligible for use in laminated substrates. The polymer can be a homopolymer (made up of one monomer), a heteropolymer/copolymer (made up of two or more monomers) or a block copolymer (made up of two or more different polymeric units). Examples of suitable polymers are polyolefins, such as polyethylene and polypropylene as well as grafted polyolefins; vinyl polymers, such as polystyrene, polymethyl methacrylate, polyvinyl chloride, polyvinylidene chloride or polyvinylidene fluoride, and blends of two or more polymers. Preferred polymers are polyolefins, vinyl polymers, polyesters, polycarbonates, polyamides, polyurethanes, polyepoxides, polyvinylalcohol, polyvinylbutyral, polyvinylacetaat, polyethers, polythioethers or polytetrafluoro ethylene.

In a further embodiment of the invention, the polymer is a thermoplastic polymer. Examples of thermoplastic polymers include polyethylene, polypropylene, grafted polyolefins, and polystyrene; polyesters such as polyethylene terephthalate (PET), polyethylene furanoate (PEF), polybutylene terephthalate (PBT), polytrimethylene terephthalate (PTT) and polyethylene naphthalate (PEN); biodegradable polyesters such as polylactic acid (PLA), polyglycolic acid (PGA) and poly(glycolide-co-lactide) (PGLA); polyamides such as nylon 6, nylon 1,6 and nylon 6,6; acetal (co)polymers, such as polyoxymethylene (POM); rubbers, such as natural rubber (NR), styrene-butadiene rubber (SBR), polyisoprene (IR), polybutadiene (BR), polyisobutylene (IIR), halogenated polyisobutylene, butadiene nitrile rubber (NBR), hydrogenated butadiene nitril (HNBR), styrene-isoprene-styrene (SIS) and similar styrenic block copolymers, poly(epichlorohydrin) rubbers (CO, ECO, GPO), silicon rubbers (Q), chloroprene rubber (CR), ethylene propylene rubber (EPM), ethylene propylene diene rubber (EPDM), polysulfide rubber (T), fluorine rubbers (FKM), ethane-vinylacetate rubber (EVA), polyacrylic rubbers (ACM), polynorbornene (PNR); polyurethanes (AU/EU) and polyester/ether thermoplastic elastomers. Preferred polymers are polyolefins, polyesters and biodegradable polyesters. More preferred are polyethylene, polypropylene, and polyethylene terephthalate.

Particularly preferred are polymers or copolymers obtained by polymerization of at least one ethylenically unsaturated monomer. Such polymers include polyolefins and modified polyolefins, which are known to the man skilled-in-the-art. The polyolefin or modified polyolefin can be a homopolymer or a copolymer, terpolymer of grafted polymer. Examples of such (modified) polyolefins include polyethylene, polypropylene, polybutylene, polystyrene, polyvinyl chloride, polyvinylidene chloride and ethylene-propylene rubber, propylene-butene copolymer, ethylene-vinyl chloride copolymer, ethylene-vinyl acetate copolymer, acrylonitrile-butadiene-styrene copolymer (ABS), acrylonitrile-acrylate-styrene copolymer (AAS), methyl methacrylate-butadiene-styrene copolymer (MBS), chlorinated polyethylene, chlorinated polypropylene, ethylene-acrylate copolymer, vinyl chloride-propylene copolymer, maleic anhydride-grafted polyolefin, maleic acid-grafted polyolefin, and mixtures thereof. More preferred polyolefins are polyethylene, polypropylene, polystyrene and polyvinyl chloride.

Suitable examples of polyethylene are high-density polyethylene (HDPE), low-density polyethylene (LOPE), straight chain low-density polyethylene (LLDPE), ultra-low density polyethylene and ultra-high molecular weight polyethylene. Further examples of ethylene-based copolymers include ethylene-vinyl acetate copolymer (EVA), ethylene-ethyl acetate copolymer (EEA), ethylene-methyl acrylate copolymer (EMA) and ethylene-acrylic acid copolymer (EAA).

In one embodiment of the invention, the laminated substrate is used in the process in an amount of at least 10% by weight (wt %), based on the total weight of laminated substrate and recycling composition. Preferably, the laminated substrate is present in an amount of at least 20 wt %, more preferably at least 30 wt %, even more preferably at least 35 wt % and most preferably at least 40 wt %, and preferably at most 99 wt %, more preferably at most 95 wt %, even more preferably at most 90 wt %, even more preferably at most 85 wt %, even more preferably at most 80 wt %, and most preferably at most 75 wt %, based on the total weight of laminated substrate and recycling composition.

In one embodiment of the invention, the polymer of the laminated substrate is used in the process in an amount of at least 10% by weight (wt %), based on the total weight of polymer and recycling composition. Preferably, the polymer is present in an amount of at least 20 wt %, more preferably at least 30 wt %, even more preferably at least 35 wt % and most preferably at least 40 wt %, and preferably at most 99 wt %, more preferably at most 95 wt %, even more preferably at most 90 wt %, even more preferably at most 85 wt %, even more preferably at most 80 wt %, and most preferably at most 75 wt %, based on the total weight of polymer and recycling composition.

The polymer in the laminated substrate of the invention may comprise additives commonly used in polymer-containing compositions including pigments and dyes, heat stabilizers, anti-oxidants, fillers, such as hydroxyapatite, silica, carbon black, glass fibers and other inorganic materials, flame retardants ,nucleating agents, impact modifiers, plasticizers, rheology modifiers, cross-linking agents, anti-gassing agents, surfactants, flow controlling agents, ultraviolet light (UV) stabilizers, adhesion enhancing promoters, waxes, matting agents, defoamers and curing catalysts. Examples of pigments and dyes include metal oxides like iron oxide, zinc oxide and; metal hydroxides; metal sulfides, metal sulfates, metal carbonates, such as calcium carbonate; carbon black, china clay, phthalo blues and greens, organo reds and other organic dyes.

The additives are optional and can be chosen according to need in amounts as desired. The laminated substrate polymer of the invention may comprise the additives in an amount of at most 30% by weight (wt %), based on the total weight of the used polymer. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the laminated substrate.

Altrnatively and additionally, the polymer of the laminated substrate of the invention may comprise the additives in an amount of at most 30% by weight (wt %), based on the total weight of the polymer. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the polymer.

The remaining part of the polymer in the laminated substrate may be comprised of other components commonly used in polymers. With the polymer and the additives, the other components add up to 100 wt % of the total weight of the polymer. Additionally, remaining part of the laminated substrate may be comprised of other components commonly used in laminated substrates. With the laminated substrate, the polymer and the additives, the other components add up to 100 wt % of the total weight of the laminated substrate.

The recycling composition can be any composition described above. In one embodiment of the invention, the recycling composition is used in the process in an amount of at most 90% by weight (wt %), based on the total weight of the laminated substrate and recycling composition. Preferably, the recycling composition is present in an amount of at most 80 wt %, more preferably at most 70 wt %, even more preferably at most 65 wt % and most preferably at most 60 wt %, and preferably at least 1 wt %, more preferably at least 5 wt %, even more preferably at least 10 wt %, even more preferably at least 15 wt %, even more preferably at least 20 wt %, and most preferably at least 25 wt %, based on the total weight of laminated substrate and recycling composition.

In one embodiment of the invention, the recycling composition is used in the process in an amount of at most 90% by weight (wt %), based on the total weight of the polymer of the laminated substrate and recycling composition. Preferably, the recycling composition is present in an amount of at most 80 wt %, more preferably at most 70 wt %, even more preferably at most 65 wt % and most preferably at most 60 wt %, and preferably at least 1 wt %, more preferably at least 5 wt %, even more preferably at least 10 wt %, even more preferably at least 15 wt %, even more preferably at least 20 wt %, and most preferably at least 25 wt %, based on the total weight of polymer and recycling composition.

In step (a) of the process of the invention the laminated substrate and the recycling composition are contacted to obtain a mixture. The recycling composition can be mixed with the laminated substrate in one go, or intermittently in multiple portions. Alternatively, the laminated substrate can be mixed with the recycling composition in one go, or intermittently in multiple portions. Preferably, the laminated substrate and the recycling composition are mixed while the mixture is stirred mechanically.

The process of the invention comprises the step of optionally shredding the laminated substrate before, during and/or after step (a). Such a shredding process is well known in the art, and is already used on commercial scale in current recycling procedures. Upon shredding of the laminated substrate, the shredded laminated substrate pieces can be more easily accessed by the recycling composition, and the layers in the laminated substrate can be more easily delaminated. Moreover, additives can be more effectively removed from the used polymer. Also the dissolution rate of the polymer in the laminated substrate may improve. Step (b) of the process may increase the speed of the process and hence may shorten the recycling processing time. The shredding step may be performed before contacting the laminated substrate with the recycling composition. It is also envisaged that first the laminated substrate is contacted with a part of the recycling composition before commencing with the shredding step, after which the rest of the recycling composition is added. Also the shredding step (b) may be performed after the recycling composition is mixed with the laminated substrate.

The process of the invention comprises the step of optionally increasing the temperature of the mixture of laminated substrate and recycling composition obtained in steps (a) or (b). The temperature of the mixture may be increased to a temperature below the glass temperature of the polymer in the laminated substrate. At this temperature, delamination generally occurs faster. Moreover, the additives in the polymer generally dissolve more rapidly while maintaining the polymer in its solid form. The temperature may also be increased to above the temperature at which the polymer per se dissolves. Preferably, the temperature of step (c) is increased to above the glass temperature of the polymer. In one embodiment, the temperature of the mixture is at least 20° C., preferably at least 30° C., more preferably at least 40° C., even more preferably at least 50° C., even more preferably at least 80° C. and most preferably at least 100° C., and preferably at most 230° C., more preferably at most 200° C., even more preferably at most 180° C. and most preferably at most 150° C.

In step (d) of the process of the invention, the recycling composition comprising at least part of the polymer and/or additives present in the laminated substrate is separated from the substrate. The term “substrate” refers to product after delamination of at least one polymer layer from the laminated substrate. This term also encompasses products where multiple layers have been removed/delaminated, e.g. when only the metal layer remains after delamination of the laminated substrate (i.e. metal substrate). When the laminated substrate is exposed to the recycling composition, at least one polymer layer is delaminated from the laminated substrate, the polymer layer may be in its solid form or when the temperature is increased to above the glass temperature of the polymer the polymer is dissolved in the recycling composition. Additionally, the additives like pigments and dyes can be extracted from the polymer in the laminated substrate and dissolved in the recycling composition. When the laminated substrate is made up of layers of at least two different polymers, delamination of the corresponding polymer layers to obtain individual separated polymer layers, enables separation of these polymer layers using conventional techniques, e.g. using the difference in density of the polymers. The temperature of the mixture may be increase to above the glass transition temperature of the first polymer and below the glass transition temperature of the second polymer, while dissolving the first polymer in the recycling composition. In this way, the polymers can be separated by removal of the liquid with the dissolved polymer from the solid second polymer using conventional techniques, e.g. decanting and/or filtering. When the laminated substrate is made up of at least one polymer layer and least one metal layer and/or paper layer, delamination of the polymer layer from the metal or paper substrate may also allow the polymer layer to be separated from the metal or paper substrate using conventional techniques, e.g. using the difference in density of the materials. When the temperature is chosen such that the polymer layer that is delaminated from the laminated substrate is dissolved in the recycling composition, the liquid can be separated from the solid substrate using conventional separation techniques well known to the skilled person, such as decanting or filtering. The polymer can then be separated by lowering the temperature of the liquid to below the glass transition temperature until the polymer solidifies (and preferably above the temperature at which any one of the additives deposits), and subsequently removing the liquid comprising the additives dissolved therein from the solidified polymer with known separation techniques. Preferably, the temperature of step (e) is decreased to below the glass temperature of the polymer. In one embodiment, the temperature of the mixture is at most 80° C., preferably at most 70° C., more preferably at most 60° C., even more preferably at most 50° C., even more preferably at most 40° C. and most preferably at most 30° C., and preferably at least 0° C., more preferably at least 5° C., even more preferably at least 10° C. and most preferably at least 15° C.

In a further step of the process, the additives can be obtained using conventional separation techniques. Lowering the temperature to below 0° C. (or even lower temperatures) enables deposition of some or all of the additives. The additives may be re-used in polymer materials or any other suitable use. Additionally, the recycling composition can be re-used in the process of the invention.

The invention further pertains to the recycled polymer obtained with the process of the invention.

Separating Two or More Polymers

The invention further pertains to a process for separating a first used polymer and a second used polymer comprising the steps of:

(a) contacting the first and second used polymers with a recycling composition comprising a lactam and/or a eutectic composition comprising a lactam and a eutecting agent;

(b) optionally shredding the first and/or second used polymer before, during and/or after step (a);

(c) optionally increasing the temperature of the mixture;

(d) separating the recycling composition comprising at least part of the additives present in the first and/or second used polymers from the used polymers; and

(e) cooling the recycling composition and/or the first and/or second used polymer before, during and/or after step (d) to below the highest glass temperature of the first or second used polymer. The process of the invention is capable of separating and recycling at least two different polymers, i.e. the first used polymer and the second used polymer. The polymers so obtained have a relatively high quality compared to polymers obtained using current recycling processes. These recycled polymers do not need to be diluted with virgin polymer or can be diluted with far less virgin polymer. The commercial value of the polymers obtained with the inventive process is higher than the value of the currently recycled plastics. Moreover, the variety of possible uses increases compared to the currently recycled plastics.

In one embodiment, the additives are pigments and/or dyes. At relatively low temperatures even at room temperature, pigments and/or dyes may be removed from the used polymer, thereby discoloring the used polymer.

The first and second used polymers suitable for the process of the invention can be any polymer known in the art that is eligible for recycling. The first used polymer is different from the second used polymer. The first and/or second used polymer may both be thermoplasts, or one may be a thermoplast and the second may be a thermoset polymer. When one of the used polymers is a thermoset polymer, the other thermoplast polymer may be recycled which would otherwise have been lost as the thermoset polymer can generally not be recycled. The polymer can be a homopolymer (made up of one monomer), a heteropolymer/copolymer (made up of two or more monomers) or a block copolymer (made up of two or more different polymeric units). Examples of suitable polymers are polyolefins, such as polyethylene and polypropylene as well as grafted polyolefins; vinyl polymers, such as polystyrene, polymethyl methacrylate, polyvinyl chloride, polyvinylidene chloride or polyvinylidene fluoride, and blends of two or more polymers. Preferred polymers are polyolefins, vinyl polymers, polyesters, polycarbonates, polyamides, polyurethanes, polyepoxides, polyvinylalcohol, polyvinylbutyral, polyvinylacetaat, polyethers, polythioethers or polytetrafluoro ethylene.

In a further embodiment of the invention, the first used polymer and/or second used polymer is a thermoplastic polymer. Examples of thermoplastic polymers include polyethylene, polypropylene, grafted polyolefins, and polystyrene; polyesters such as polyethylene terephthalate (PET), polyethylene furanoate (PEF), polybutylene terephthalate (PBT), polytrimethylene terephthalate (PTT) and polyethylene naphthalate (PEN); biodegradable polyesters such as polylactic acid (PLA), polyglycolic acid (PGA) and poly(glycolide-co-lactide) (PGLA); polyamides such as nylon 6, nylon 1,6 and nylon 6,6; acetal (co)polymers, such as polyoxymethylene (POM); rubbers, such as natural rubber (NR), styrene-butadiene rubber (SBR), polyisoprene (IR), polybutadiene (BR), polyisobutylene (IIR), halogenated polyisobutylene, butadiene nitrile rubber (NBR), hydrogenated butadiene nitril (HNBR), styrene-isoprene-styrene (SIS) and similar styrenic block copolymers, poly(epichlorohydrin) rubbers (CO, ECO, GPO), silicon rubbers (Q), chloroprene rubber (CR), ethylene propylene rubber (EPM), ethylene propylene diene rubber (EPDM), polysulfide rubber (T), fluorine rubbers (FKM), ethane-vinylacetate rubber (EVA), polyacrylic rubbers (ACM), polynorbornene (PNR); polyurethanes (AU/EU) and polyester/ether thermoplastic elastomers. Preferred polymers are polyolefins, polyesters and biodegradable polyesters. More preferred are polyethylene, polypropylene, and polyethylene terephthalate.

Particularly preferred are polymers or copolymers obtained by polymerization of at least one ethylenically unsaturated monomer. Such polymers include polyolefins and modified polyolefins, which are known to the man skilled-in-the-art. The polyolefin or modified polyolefin can be a homopolymer or a copolymer, terpolymer of grafted polymer. Examples of such (modified) polyolefins include polyethylene, polypropylene, polybutylene, polystyrene, polyvinyl chloride, polyvinylidene chloride and ethylene-propylene rubber, propylene-butene copolymer, ethylene-vinyl chloride copolymer, ethylene-vinyl acetate copolymer, acrylonitrile-butadiene-styrene copolymer (ABS), acrylonitrile-acrylate-styrene copolymer (AAS), methyl methacrylate-butadiene-styrene copolymer (MBS), chlorinated polyethylene, chlorinated polypropylene, ethylene-acrylate copolymer, vinyl chloride-propylene copolymer, maleic anhydride-grafted polyolefin, maleic acid-grafted polyolefin, and mixtures thereof. More preferred polyolefins are polyethylene, polypropylene, polystyrene and polyvinyl chloride.

Suitable examples of polyethylene are high-density polyethylene (HDPE), low-density polyethylene (LOPE), straight chain low-density polyethylene (LLDPE), ultra-low density polyethylene and ultra-high molecular weight polyethylene. Further examples of ethylene-based copolymers include ethylene-vinyl acetate copolymer (EVA), ethylene-ethyl acetate copolymer (EEA), ethylene-methyl acrylate copolymer (EMA) and ethylene-acrylic acid copolymer (EAA).

In one embodiment of the invention, the first and second used polymer is used in the process in an amount of at least 10% by weight (wt %), based on the total weight of first and second used polymer and recycling composition. Preferably, the first and second used polymer is present in an amount of at least 20 wt %, more preferably at least 30 wt %, even more preferably at least 35 wt % and most preferably at least 40 wt %, and preferably at most 99 wt %, more preferably at most 95 wt %, even more preferably at most 90 wt %, even more preferably at most 85 wt %, even more preferably at most 80 wt %, and most preferably at most 75 wt %, based on the total weight of first and second used polymer and recycling composition.

In one embodiment of the invention, the first used polymer and the second used polymer are presented as a mixture. In one embodiment, the first used polymer is present in the mixture in an amount of at least 10% by weight (wt %), based on the total weight of first and second used polymer. Preferably, the first used polymer is present in an amount of at least 20 wt %, more preferably at least 30 wt %, even more preferably at least 35 wt % and most preferably at least 40 wt %, and preferably at most 99 wt %, more preferably at most 95 wt %, even more preferably at most 90 wt %, even more preferably at most 85 wt %, even more preferably at most 80 wt %, and most preferably at most 75 wt %, based on the total weight of first and second used polymer.

In one embodiment, the second used polymer is present in the mixture in an amount of at least 10% by weight (wt %), based on the total weight of first and second used polymer. Preferably, the second used polymer is present in an amount of at least 20 wt %, more preferably at least 30 wt %, even more preferably at least 35 wt % and most preferably at least 40 wt %, and preferably at most 99 wt %, more preferably at most 95 wt %, even more preferably at most 90 wt %, even more preferably at most 85 wt %, even more preferably at most 80 wt %, and most preferably at most 75 wt %, based on the total weight of first and second used polymer.

The first and/or second used polymer of the invention may comprise additives commonly used in polymer-containing compositions including pigments and dyes, heat stabilizers, anti-oxidants, fillers, such as hydroxyapatite, silica, carbon black, glass fibers and other inorganic materials, flame retardants, nucleating agents, impact modifiers, plasticizers, rheology modifiers, cross-linking agents, anti-gassing agents, surfactants, flow controlling agents, ultraviolet light (UV) stabilizers, adhesion enhancing promoters, waxes, matting agents, defoamers and curing catalysts. Examples of pigments and dyes include metal oxides like iron oxide, zinc oxide and; metal hydroxides; metal sulfides, metal sulfates, metal carbonates, such as calcium carbonate; carbon black, china clay, phthalo blues and greens, organo reds and other organic dyes.

The additives are optional and can be chosen according to need in amounts as desired. The first used polymer of the invention may comprise the additives in an amount of at most 30% by weight (wt %), based on the total weight of the first used polymer. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the first used polymer.

In one embodiment, the second used polymer of the invention may comprise the additives in an amount of at most 30% by weight (wt %), based on the total weight of the second used polymer. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the second used polymer.

The remaining part of the first used polymer may be comprised of other components commonly used in polymers. With the polymer and the additives, the other components add up to 100 wt % of the total weight of the first used polymer. The remaining part of the second used polymer may be comprised of other components commonly used in polymers. With polymer and the additives, the other components add up to 100 wt % of the total weight of the second used polymer.

The recycling composition can be any composition described above. In one embodiment of the invention, the recycling composition is used in the process in an amount of at most 90% by weight (wt %), based on the total weight of first and second used polymer and recycling composition. Preferably, the recycling composition is present in an amount of at most 80 wt %, more preferably at most 70 wt %, even more preferably at most 65 wt % and most preferably at most 60 wt %, and preferably at least 1 wt %, more preferably at least 5 wt %, even more preferably at least 10 wt %, even more preferably at least 15 wt %, even more preferably at least 20 wt %, and most preferably at least 25 wt %, based on the total weight of first and second used polymer and recycling composition.

In step (a) of the process of the invention the first and second used polymer and the recycling composition are contacted to obtain a mixture. It is also envisaged that the used polymer mixture may contain further used polymers. The recycling composition can be mixed with the first and second used polymer in one go, or intermittently in multiple portions. Alternatively, the used polymer can be mixed with the recycling composition in one go, or intermittently in multiple portions. Preferably, the first and second used polymer and the recycling composition are mixed while the mixture is stirred mechanically. In one embodiment, the first and second used polymers are presented as a mixture before being contacted with the recycling composition. In practice, the first and second polymers are collected from garbage and consequently are mixed together. The present process does not require to be separated before processing them further.

The process of the invention comprises the step of optionally shredding the used polymer before, during and/or after step (a). Upon shredding of the first and second used polymer, the shredded polymer pieces can be more easily accessed by the recycling composition, and additives can be more effectively removed from the used polymer. Also the dissolution rate of the first and/or second used polymer may improve. Step (b) of the process may increase the speed of the process and hence may shorten the recycling processing time. The shredding step may be performed before contacting the first and second used polymer with the recycling composition. It is also envisaged that first the first and second used polymer are contacted with a part of the recycling composition before commencing with the shredding step, after which the rest of the recycling composition is added. Also the shredding step (b) may be performed after the recycling composition is mixed with the first and second used polymer.

The process of the invention comprises the step of optionally increasing the temperature of the mixture of first and second used polymer and recycling composition obtained in steps (a) or (b). The temperature of the mixture may be increased to a temperature below the glass temperature of the first and second used polymer. At this temperature the additives generally dissolve more rapidly while maintaining the polymers in its solid form. The temperature may also be increased to above the temperature at which the first used polymer per se dissolves. Preferably, the temperature of step (c) is increased to above the glass temperature of the first used polymer and below the glass transitin temperature of the second used polymer. In this way, the second used polymer remains solid while the first used polymer is dissolved in the recycling composition, which in turn enables an easy separation of the first and second used polymers. It is also envisaged to increase the temperature to above the glass transition temperature of the second used polymer in order to dissolve the second used polymer. In this way, the additives can also be more easily removed from the second used polymer. In one embodiment, the temperature of the mixture is at least 20° C., preferably at least 30° C., more preferably at least 40° C., even more preferably at least 50° C., even more preferably at least 80° C. and most preferably at least 100° C., and preferably at most 230° C., more preferably at most 200° C., even more preferably at most 180° C. and most preferably at most 150° C.

In step (d) of the process of the invention, the recycling composition comprising at least part of the additives present in the first and second used polymer is separated from the first and second used polymer. When the used polymer is exposed to the recycling composition, additives like pigments and dyes can be extracted from the used polymer and dissolved in the recycling composition. The liquid can be separated from the solid used polymer using conventional separation techniques well known to the skilled person, such as decanting or filtering. When the temperature is increased to above the glass transition temperature of the first used polymer and below the glass transition temperature of the second used polymer, the first used polymer is generally dissolved in the recycling composition while the second used polymer remains solid. The first and second polymers can then be separated using conventional separation techniques, such as decanting and filtering. At such temperatures faster extraction of the additives from the first and second used polymers and/or a more speedy dissolution of the first used polymer can be achieved. The first used polymer can subsequently be separated from the liquid by lowering the temperature to below the glass transition temperature until the polymer solidifies (and preferably above the temperature at which any one of the additives deposits), and subsequently removing the liquid comprising the additives dissolved therein from the solidified first used polymer with known separation techniques. Preferably, the temperature of step (e) is decreased to below the glass temperature of the first used polymer. In one embodiment, the temperature of the mixture is at most 80° C., preferably at most 70° C., more preferably at most 60° C., even more preferably at most 50° C., even more preferably at most 40° C. and most preferably at most 30° C., and preferably at least 0° C., more preferably at least 5° C., even more preferably at least 10° C. and most preferably at least 15° C.

Alternatively, the temperature in step (c) of the process is increased to above the glass transition temperature of the second used polymer. At such temperatures the second used polymer may also dissolve together with the first used polymer. This allows for a faster extraction of the additives and faster dissolution of both first and second used polymers. Subsequently, the temperature of the mixture can be decreased to below the glass transition temperature of the second used polymer and above the glass transition temperature of the first used polymer so as to solidify the second used polymer, while maintaining the first used polymer in solution. The solidified second used polymer can be separated using conventional techniques, e.g. decanting and/or filtering. The resulting liquid can be cooled to below the glass transition temperature of the first used polymer to solidify the first used polymer while keeping the additives of the first and/or second used polymers in solution. The solidified first used polymer can be separated using conventional techniques, e.g. decanting and/or filtering.

In a further step of the process, the additives can be obtained using conventional separation techniques. Lowering the temperature to below 0° C. (or even lower temperatures) enables deposition of some or all of the additives. The additives may be re-used in polymer materials or any other suitable use. Additionally, the recycling composition can be re-used in the process of the invention.

The invention further pertains to the recycled first polymer obtained with the process of the invention. The invention further pertains to the recycled second polymer obtained with the process of the invention.

Removing Cured Coating from a Coated Substrate

The invention further pertains to a process for removing the coating from a coated substrate comprising the steps of:

(a) contacting the coated substrate with a recycling composition comprising a lactam and/or a eutectic composition comprising a lactam and a eutecting agent;

(b) optionally shredding the coated substrate before, during and/or after step (a);

(c) optionally increasing the temperature of the mixture or the coated substrate;

(d) separating the cured coating composition from the substrate. With the process of the invention cured coatings and/or inks can be removed from coated substrates, in particular both outside and inside lacquer layers can be removed. The substrates are generally clean without residues of the coating, rendering the substrates suitable to be re-used. The recycling composition of the invention is capable of disconnecting the coating composition adhered to the substrate from the substrate to obtain a clean substrate. The cured coating composition generally comes off the substrate in pieces. The process is relatively mild and generally does not significantly affect the substrate. As the adhesion of the cured coatings onto the substrate is generally relatively strong, conventional techniques (i.e. burning off the coating) are quite harsh and generally leave residue on the substrate which is undesirable when the substrate is to be re-used as it will be contaminated by the carbon residue. The current process overcomes all these issues. Moreover, the recycling composition is generally environmentally friendly. Also the energy consumption of the inventive process will be significantly less than the energy consumed in the conventional burning-off processes.

The coating on the substrate can be any coating known in the art. Generally, such coatings are cured. It is also envisaged that cured coating compositions can be the result of multiple coating layers, including cured coatings from wet-on-wet ink processes. In the context of the present application the term “cure” or “cured” refers to the process of hardening of the coating composition by polymerization and/or crosslinking. This curing process can be initiated by exposure to ultraviolet radiation, heat, such as by infrared radiation, by microwave radiation or by heating, e.g. in an oven, electron beams and chemical additives. The coating compositions of the invention preferably cure through exposure to ultraviolet radiation and heat, preferably through heat. Some coating compositions, e.g. decorative coating compositions, may cure at room temperature. The coating composition before curing may comprise a first resin. The composition may further comprise one or more other resins as the skilled person will appreciate.

The first resin can be any resin known in the art and used in coating compositions. The first resin of the invention may be a monomer, an oligomer or polymer. The first resin may be an alkyd resin, an acrylic resin, a polyester resin, a polyester polyol resin, a silicone-based resin, a phenolic resin, a urethane-based or isocyanate based resin, an aminoplast and an epoxy resin. Examples of alkyd resins include drying and non-drying alkyd resins. Examples of polyacrylate resins include polymers derived from one or more of acrylate, methacrylate, ethyl acrylate, 2-chloroethyl vinyl ether, 2-ethylhexyl acrylate, 2-hydroxyethyl methacrylate, butyl acrylate, butyl methacrylate, 2-hydroxypropyl methacrylate, 3-hydroxypropyl methacrylate, 2-hydroxypropyl methacrylate, 3-hydroxypropyl methacrylate, hydroxystearyl acrylate and hydroxystearyl methacrylate. Examples of suitable monomeric aminoplasts include condensation products of an aldehyde and methylurea, glycoluril, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 2,4,6-triethyl-triamino-1,3,5-triazine, 1,3,5-triaminobenzene and melamine. Examples of phenolic resins include phenol-formaldehyde-based resins such as novolacs and resols. Examples of isocyanate-based resins include toluene diisocyanate (TDI), methylene diphenyl diisocyanate (MDI), 1,6-hexamethylene diisocyanate (HMDI), isophorone diisocyanate (IPDI) and 4,4′-diisocyanato dicyclohexylmethane (H₁₂MDI). Examples of epoxy resins include bisphenol A epoxy resins, bisphenol F epoxy resins, novolac epoxy resins, aliphatic epoxy resins, cycloaliphatic epoxy resins and glycidyl amine epoxy resins.

In one embodiment of the invention, the coating composition comprises the first resin in an amount of at least 10% by weight (wt %), based on the total weight of the coating composition. Preferably, the first resin is present in an amount of at least 15 wt %, more preferably at least 20 wt %, even more preferably at least 30 wt %, even more preferably at least 40 wt %, even more preferably at least 50 wt % and most preferably at least 60 wt %, and preferably at most 95 wt %, more preferably at most 90 wt %, even more preferably at most 85 wt % and most preferably at most 80 wt %, based on the total weight of the coating composition.

In another embodiment of the invention, the coating composition comprises solids in an amount of at least 15% by weight (wt %), based on the total weight of the coating composition. Preferably, the solids are present in an amount of at least 20 wt %, more preferably at least 30 wt %, even more preferably at least 40 et %, even more preferably at least 50 wt %, and most preferably at least 60 wt %, and preferably at most 95 wt %, more preferably at most 90 wt %, even more preferably at most 80 wt % and most preferably at most 75 wt %, based on the total weight of the coating composition. The term “solids” is known to the man skilled in the art, and generally refers to the solid and/or non-volatile material (e.g. reactive diluents/solvents) in the coating composition; typically the solids include the resins, pigments, dyes, catalyst, etc. and does not include solvents that evaporate during the curing process. The amount of solids may also be referred to as “solids content”.

The remaining part of the coating composition may be comprised of other components commonly used in coating compositions. With the first resin the other components add up to 100 wt % of the total weight of the coating composition.

In an embodiment of the invention, the coating composition of the invention can be further diluted by a solvent to obtain a solids content below 40 wt %. For certain applications, such as the application of extremely thin coating layers, this may be warranted. In such case, the solids content in the coating composition of the invention may be preferably at most 35 wt %, more preferably at most 30 wt % and most preferably at most 25 wt %, and preferably at least 1 wt %, more preferably at least 2 wt %, even more preferably at least 5 wt %, and most preferably at least 10 wt %.

Alternatively, the coating compositions with the higher solids content (above 50 wt %) may be diluted with a suitable solvent, and optionally additives, just prior to application to a substrate. The dilution level may be used as desired, and the skilled person is well capable of diluting in an appropriate manner.

The coating composition of the invention may further comprise a solvent. The solvent may be any suitable solvent known in the art. Preferred solvents are reactive solvents that comprise a functional group capable of reacting with the first resin. The functional group may be hydroxyl, amine or thiol. Preferably, the functional group is a hydroxyl or an amine. Examples of reactive solvents include alcohols, such as methanol, ethanol, diethanol, amino ethanol, glycol, n-propanol, iso-propanol and ethanethiol, ethylene glycol, propylene glycol and neopentyl glycol; and amines, such as methyl amine, ethanol amine, dimethyl amine, methyl ethanol amine, diphenyl amine, trimethyl amine, triphenyl amine and piperidine; and acrylates such as acrylate, methacrylate, ethyl acrylate, 2-chloroethyl vinyl ether, 2-ethylhexyl acrylate, 2-hydroxyethyl methacrylate, butyl acrylate, butyl methacrylate, 2-hydroxypropyl methacrylate, 3-hydroxypropyl methacrylate, 2-hydroxypropyl methacrylate, and 3-hydroxypropyl methacrylate; and water.

Examples of non-reactive solvents include Solvent Naphtha®, heavy benzene, various Solvesso® grades, various Shellsol® grades and Deasol®, various white spirits, mineral turpentine oil, tetralin, decalin, methyl ethyl ketone, acetone and methyl n-propyl ketone. Non-reactive solvents that are incorporated at least partially and preferably completely, into the cured resin are preferred. Preferably, the non-reactive solvent has a boiling point above the curing temperature, preferably above 250° C. The coating composition of the invention may comprise a reactive solvent and a non-reactive solvent, a combination of two or more solvents, or a combination of two or more reactive solvents. Coating compositions comprising a reactive solvent and/or water are preferred.

The coating composition of the invention may comprise the non-reactive solvent and/or the reactive solvent in an amount of at most 30% by weight (wt %), based on the total weight of the coating composition. Preferably, the non-reactive solvent and/or the reactive solvent is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the coating composition.

In a further embodiment, the coating composition of the invention may comprise water in an amount of at most 85% by weight (wt %), based on the total weight of the coating composition. Preferably, the water is present in an amount of at most 70 wt %, more preferably at most 60 wt %, even more preferably at most 50 wt %, even more preferably at most 40 wt % and most preferably at most 30 wt %, and preferably at least 1 wt %, more preferably at least 2 wt %, even more preferably at least 5 wt % and most preferably at least 10 wt %, based on the total weight of the coating composition.

The coating composition may further comprise additives commonly used in coating compositions including pigments and dyes, surfactants, flow controlling agents, thixotropic agents, anti-gassing agents, wetting agents, ultraviolet light stabilizers, adhesion enhancing promoters, waxes, filling agents, drying stabilizers, siccatives, matting agents, defoamers, and curing catalysts including oxidation catalysts such as metal carboxylates. The additives can be any additive known in the art. Examples of pigments and dyes include metal oxides like titanium dioxide, iron oxide, zinc oxide and chromium oxide; metal hydroxides; metal sulfides, metal sulfates, metal carbonates such as calcium carbonate; carbon black, china clay, phthalo blues and greens, organo reds and other organic dyes. The coating compositions of the invention may increase the color intensity of the pigments and dyes. This may lead to a reduction in the total amount of pigment and/or dye used. The curing catalyst is preferably a strong acid. Examples of suitable curing catalysts include p-toluenesulfonic acid, xylenesulfonic acid, dodecyl benzene sulfonic acid, dinonyl naphthalene sulfonic acid, dinonyl naphthalene disulfonic acid, fluorosulfuric acid, trifuoromethane sulfonic acid, hexafluoro antimonate compounds and catalysts derived thereof, phosphoric acid and sulfuric acid. Examples of ultraviolet light stabilizers include benzophenone, such as hydroxydodecyl benzophenone, 2,4-dihydroxy-3′,5′-di-t-butylbenzophenone, 2-hydroxy-4-acryloxyethoxybenzophenone and 2-hydroxy-4-methoxy-2′-carboxybenzophenone.

The coating composition of the invention may comprise the additives in an amount of at most 30% by weight (wt %), based on the total weight of the coating composition. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the coating composition.

Such coating compositions can be applied to the substrate and subsequently cured. The coated substrate may further be shaped as desired, e.g. to a food or beverage container.

The substrate of the invention can be any substrate known in the art. The substrate may be porous or non-porous. Examples of suitable substrates include metals, such as aluminum, aluminum alloys, steel, steel alloys, tin, tin alloys, zinc, zinc alloys, chrome and chrome alloys; glass such as fused silica glass, aluminosilicate glass, soda-lime-silica glass, borosilicate glass and lead-oxide glass; ceramics, such as porcelain, bone china, alumina, ceria, zirconia, carbides, borides, nitrides and silicides; plastic such as functionalized polyethylene (PE), functionalized polypropylene (PP), polyethylene terephthalate (PET), polyvinyl chloride (PVC) and nylons; and wood. Preferably, the substrate is metal, in particular aluminum.

Examples of coated substrates include food and beverage cans, coil coatings, automotive parts, bridges, boats and household appliances.

The process of the invention can be performed in a dedicated factory where coated substrates can be brought, e.g. coated substrate found in the trash like soda or beer cans. The process can also be performed at the place where the coated substrate is located, e.g a car repair shop or bridge that is to be coated again.

The recycling composition can be any composition described above. In one embodiment of the invention, the recycling composition is used in the process in an amount of at most 90% by weight (wt %), based on the total weight of coated substrate and recycling composition. Preferably, the recycling composition is present in an amount of at most 80 wt %, more preferably at most 70 wt %, even more preferably at most 65 wt % and most preferably at most 60 wt %, and preferably at least 1 wt %, more preferably at least 5 wt %, even more preferably at least 10 wt %, even more preferably at least 15 wt %, even more preferably at least 20 wt %, and most preferably at least 25 wt %, based on the total weight of coated substrate and recycling composition.

When the recycling composition is applied to the coated substrate the amount of recycling composition is at least 0.01 g/cm², preferably at least 0.1 g/cm², more preferably at least 0.2 g/cm², and most preferably at least 0.5 g/cm², and preferably at most 100 g/cm², more preferably at most 50 g/cm², even more preferably at most 20 g/cm², and most preferably at most 10 g/cm².

In step (a) of the process of the invention the coated substrate and the recycling composition are contacted to obtain a mixture. Alternatively, the recycling composition can be applied to the coated substrate. The recycling composition can be contacted and/or mixed with the coated substrate in one go, or intermittently in multiple portions. Alternatively, the coated substrate can be contacted and/or mixed with the recycling composition in one go, or intermittently in multiple portions. Preferably, the coated substrate and the recycling composition are mixed while the mixture is stirred mechanically.

The process of the invention comprises the step of optionally shredding the coated substrate before, during and/or after step (a). Such a shredding process is well known in the art, and is already used on commercial scale in current recycling procedures. Upon shredding of the coated substrate, the shredded coated substrate pieces can be more easily accessed by the recycling composition, and the cured coating in the coated substrate can be more easily delaminated or detached. Step (b) of the process may increase the speed of the process and hence may shorten the recycling processing time. The shredding step may be performed before contacting the coated substrate with the recycling composition. It is also envisaged that first the coated substrate is contacted with a part of the recycling composition before commencing with the shredding step, after which the rest of the recycling composition is added. Also the shredding step (b) may be performed after the recycling composition is mixed with the coated substrate. When only (a part of) the cured coating is to be removed without changing the physical appearance of the substrate (e.g. with bridges and boats), step (b) is omitted.

The process of the invention comprises the step of optionally increasing the temperature of the mixture of (optionally shredded) coated substrate and recycling composition obtained in steps (a) or (b). At higher temperature the penetration of the coating and/or the detachment of the coating from the substrate proceeds faster. In one embodiment, the temperature of the mixture is at least 20° C., preferably at least 30° C., more preferably at least 40° C., even more preferably at least 50° C., even more preferably at least 80° C. and most preferably at least 100° C., and preferably at most 230° C., more preferably at most 200° C., even more preferably at most 180° C. and most preferably at most 150° C. In the case that the recycling composition is applied to the coated substrate, the temperature is optionally increased to improve the penetration efficiency and removal rate of the coating. The temperature can be increase by heating the substrate itself or heating the coated substrate using conventional heaters. In one embodiment, the temperature of the coated substrate is at least 20° C., preferably at least 30° C., more preferably at least 40° C., even more preferably at least 50° C., even more preferably at least 80° C. and most preferably at least 100° C., and preferably at most 230° C., more preferably at most 200° C., even more preferably at most 180° C. and most preferably at most 150° C.

In step (d) of the process of the invention, the recycling composition comprising at least part of the cured coating present in the coated substrate is separated from the substrate. In the context of this inventive process, the term “substrate” refers to product after removal of the cured coating from the coated substrate. This term also encompasses products where multiple coating layers have been removed/delaminated, e.g. when only the metal layer remains after the coating layers are all removed (i.e. metal substrate). The separation can be performed through simply wiping of the loose cured coating from the substrate. Alternatively, in case of a mixture the separation can be performed using conventional techniques, e.g. using the difference in density of the materials. The recycling composition can be obtained without the substrate and cured coating, rendering them suitable for re-use, e.g. in the process of the invention. The substrate can be obtained without any cured coating, and hence can also be re-used.

The invention further pertains to the recycled polymer obtained with the process of the invention.

Recycling Used Paper

The invention further pertains to a process for recycling of used paper comprising the steps of:

(a) contacting the used paper with a recycling composition comprising a lactam and/or a eutectic composition comprising a lactam and a eutecting agent;

(b) optionally shredding the used paper before, during and/or after step (a);

(c) optionally increasing the temperature of the mixture;

(d) separating the recycling composition comprising at least part of the additives present in the used paper from the used cellulose fibers; and

(e) cooling the recycling composition and/or the used paper before, during and/or after step (d).

The process of the invention allows for the separation of additives, such as pigments and dyes and other excipients, present in used paper from the cellulose fibers itself. In this way, clean cellulose fibers are obtained which contains considerably less or even no additives. These recycled cellulose fibers do not need to be diluted with virgin cellulose fibers or can be diluted with far less virgin cellulose fibers. The commercial value of the cellulose fibers obtained with the inventive process is higher than the value of the currently recycled paper. Moreover, the variety of possible uses increases compared to the currently recycled paper.

In one embodiment, the additives are pigments and/or dyes. At relatively low temperatures even at room temperature, pigments and/or dyes may be removed from the used paper, thereby discoloring the used paper.

In the context of the present application the term “used paper” refer to paper material that has been used and served their purpose. This paper material can be returned after use (e.g. laminated packaging like milk cartons) or can be found in collected garbage (e.g. paper labels and laminated packaging). With “used cellulose fibers” is meant the cellulose fibers obtained from used paper, that is generally without or with small amounts of additives conventionally used in paper such as SiO₂ and inks. The used paper suitable for the process of the invention can be any paper known in the art that is eligible for recycling. Examples of suitable papers include base paper, bond paper, construction paper, container board, corrugated container, corrugated medium, cover paper, envelope paper, form bond, free sheet, insulating board, kraft bag paper, kraft wrapping paper, mechanical paper, newspaper, napkin stock, offset paper, packaging paper, paperboard like chipboard, box board, bleached board, liner board and clay coated box board; solid bleached bristols, specialty extrusion paper, specialty industrial paper, tissues like facial tissues, paper towels and specialty tissue paper; and wallboard.

In one embodiment of the invention, the used paper is used in the process in an amount of at least 10% by weight (wt %), based on the total weight of used paper and recycling composition.

Preferably, the paper is present in an amount of at least 20 wt %, more preferably at least 30 wt %, even more preferably at least 35 wt % and most preferably at least 40 wt %, and preferably at most 99 wt %, more preferably at most 95 wt %, even more preferably at most 90 wt %, even more preferably at most 85 wt %, even more preferably at most 80 wt %, and most preferably at most 75 wt %, based on the total weight of used paper and recycling composition.

The used paper of the invention may comprise additives commonly used in paper-containing compositions including pigments and dyes, fillers, such as calcium carbonate, titania, magnesium hydroxide and silica; strengtheners including wet-strength additives and dry-strength additives; optical brighteners such as stilbenes like 4,4′.diamino-2,2′-stilbenedisulfonic acid (DADS); sizing agents such as alkenyl succinic anhydride (ASA) and alkyl ketene dimer (AKD); binders such as carboxymethyl cellulose (CMC), cationic and anionic hydroxyethyl cellulose (EHEC), modified starch, styrene butadiene latex, styrene acrylic, dextrin and oxidized starch; retention agents such as polyethyleneimine and polyacrylamide. Examples of pigments and dyes include metal oxides like iron oxide, zinc oxide and; metal hydroxides; metal sulfides, metal sulfates, metal carbonates, such as calcium carbonate; carbon black, china clay, phthalo blues and greens, organo reds and other organic dyes.

The additives are optional and can be chosen according to need in amounts as desired. The used paper of the invention may comprise the additives in an amount of at most 30% by weight (wt %), based on the total weight of the used paper. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the used paper.

The remaining part of the used polymer may be comprised of other components commonly used in paper. With the paper and the additives, the other components add up to 100 wt % of the total weight of the used paper.

The recycling composition can be any composition described above. In one embodiment of the invention, the recycling composition is used in the process in an amount of at most 90% by weight (wt %), based on the total weight of used paper and recycling composition. Preferably, the recycling composition is present in an amount of at most 80 wt %, more preferably at most 70 wt %, even more preferably at most 65 wt % and most preferably at most 60 wt %, and preferably at least 1 wt %, more preferably at least 5 wt %, even more preferably at least 10 wt %, even more preferably at least 15 wt %, even more preferably at least 20 wt %, and most preferably at least 25 wt %, based on the total weight of used paper and recycling composition.

In step (a) of the process of the invention the used paper and the recycling composition are contacted to obtain a mixture. The recycling composition can be mixed with the used paper in one go, or intermittently in multiple portions. Alternatively, the used paper can be mixed with the recycling composition in one go, or intermittently in multiple portions. Preferably, the used paper and the recycling composition are mixed while the mixture is stirred mechanically. The process of the invention comprises the step of optionally shredding the used paper before, during and/or after step (a). The term “shredding” refers to the mechanical comminution of the used paper into small(er) pieces (e.g. cm-size pieces). Such a shredding process is well known in the art, and is already used on commercial scale in current recycling procedures. Upon shredding of the used paper, the shredded paper pieces can be more easily accessed by the recycling composition, and additives can be more effectively removed from the used paper. Also the dissolution rate of the used paper may improve. Step (b) of the process may increase the speed of the process and hence may shorten the recycling processing time. The shredding step may be performed before contacting the used paper with the recycling composition. It is also envisaged that first the used paper is contacted with a part of the recycling composition before commencing with the shredding step, after which the rest of the recycling composition is added. Also the shredding step (b) may be performed after the recycling composition is mixed with the used paper.

The process of the invention comprises the step of optionally increasing the temperature of the mixture of used paper and recycling composition obtained in steps (a) or (b). The temperature of the mixture may be increased to enable an easier pulping of the paper and removal of at least part of the additives. In one embodiment, the temperature of the mixture is at least 20° C., preferably at least 30° C., more preferably at least 40° C., even more preferably at least 50° C., even more preferably at least 80° C. and most preferably at least 100° C., and preferably at most 230° C., more preferably at most 200° C., even more preferably at most 180° C. and most preferably at most 150° C.

In step (d) of the process of the invention, the recycling composition comprising at least part of the additives present in the used paper is separated from the used cellulose fibers. When the used paper is exposed to the recycling composition, additives like pigments and dyes can be extracted from the used paper and dissolved or suspended in the recycling composition. The liquid can be separated from the solid used cellulose fibers using conventional separation techniques well known to the skilled person, such as decanting or filtering. Preferably, the temperature of step (e) is decreased when the temperature in step (d) is above room temperature. In one embodiment, the temperature of the mixture is at most 80° C., preferably at most 70° C., more preferably at most 60° C., even more preferably at most 50° C., even more preferably at most 40° C. and most preferably at most 30° C., and preferably at least 0° C., more preferably at least 5° C., even more preferably at least 10° C. and most preferably at least 15° C.

In a further step of the process, the additives can be obtained using conventional separation techniques. Lowering the temperature to below 0° C. (or even lower temperatures) enables deposition of some or all of the additives. The additives may be re-used in paper materials or any other suitable use. Additionally, the recycling composition can be re-used in the process of the invention.

The invention further pertains to the recycled cellulose fibers obtained with the process of the invention.

Cleaning of Used Material to be Recycled

The invention further pertains to a process for cleaning of contaminated used material comprising the steps of:

(a) contacting the contaminated used material with a recycling composition comprising a lactam and/or a eutectic composition comprising a lactam and a eutecting agent at a temperature below 80° C.;

(b) optionally shredding the contaminated used material before, during and/or after step (a);

(c) optionally increasing the temperature of the mixture while maintaining the temperature below 80° C.;

(d) separating the recycling composition comprising at least part of the contaminants present in the contaminated used material from the used material; and

(e) optionally cooling the recycling composition and/or the used material before, during and/or after step (d).

The advantage of the cleaning process of the invention is that the recycling composition allows the process to be performed at lower temperatures than what is conventionally used, i.e. 70° C. The cleaning process can even be performed at room temperature, and consequently the energy required to carry out the cleaning process is relatively low compared to conventional processes.

The contaminated used material can be any used material known in the art. Such used material is generally suitable for recycling, Examples of such used materials include used polymers; laminated substrates and coated substrates as described in the corresponding sections above. Such used materials generally are contaminated with contaminants found on used materials and known in the art including household waste, remainders of drinks and/or food, and glues (such as hot melts used to attach labels for example). The current process serves to remove those contaminants from the used materials.

The process of the invention can be performed in a dedicated factory where used materials can be brought, e.g. used materials found in the trash like soda or beer cans or collected collectively on local or national level. The process is suitable for use before or as part of any recycling process of contaminated used materials. In particular, the cleaning process of the invention can be used prior to or as part any one of the process described above.

The recycling composition can be any composition described above. In one embodiment, the recycling composition comprises a lactam and water, and optionally a eutecting agent. Preferably, the recycling composition comprises lactam in an amount of at most 15 wt %, preferably at most 10 wt %, more preferably at most 5 wt % and most preferably at most 3 wt %, and preferably at least 0.01 wt %, preferably at least 0.1 wt %, more preferably at least 0.5 wt % and most preferably at least 1 wt %. Such recycling compositions are very suitable for the process of cleaning contaminated used material. Moreover, such compositions are coste-fficient and are comparable or even cheaper than conventional cleaning compositions using surfactants.

In a further embodiment, the recycling composition comprises a hydroxide salt as indicated above. The presence of the hydroxide salt induces the formation of lactamates in the recycling composition, and generally improves the cleaning power of the recycling composition.

In one embodiment of the invention, the recycling composition is used in the process in an amount of at most 90% by weight (wt %), based on the total weight of coated substrate and recycling composition. Preferably, the recycling composition is present in an amount of at most 80 wt %, more preferably at most 70 wt %, even more preferably at most 65 wt % and most preferably at most 60 wt %, and preferably at least 1 wt %, more preferably at least 5 wt %, even more preferably at least 10 wt %, even more preferably at least 15 wt %, even more preferably at least 20 wt %, and most preferably at least 25 wt %, based on the total weight of coated substrate and recycling composition.

In step (a) of the process of the invention the first and second used polymer and the recycling composition are contacted to obtain a mixture. It is also envisaged that the used polymer mixture may contain further used polymers. The recycling composition can be mixed with the first and second used polymer in one go, or intermittently in multiple portions. Alternatively, the used polymer can be mixed with the recycling composition in one go, or intermittently in multiple portions. Preferably, the first and second used polymer and the recycling composition are mixed while the mixture is stirred mechanically. In one embodiment, the first and second used polymers are presented as a mixture before being contacted with the recycling composition. In practice, the first and second polymers are collected from garbage and consequently are mixed together. The present process does not require to be separated before processing them further.

The process of the invention comprises the step of optionally shredding the used polymer before, during and/or after step (a). Upon shredding of the contaminated used material, the shredded pieces can be more easily accessed by the recycling composition, and contaminants can be more effectively removed from the used material. Step (b) of the process may increase the speed of the process and hence may shorten the time need for cleaning and the subsequent recycling processing time. The shredding step may be performed before contacting the used material with the recycling composition. It is also envisaged that first the used material is contacted with a part of the recycling composition before commencing with the shredding step, after which the rest of the recycling composition is added. Also the shredding step (b) may be performed after the recycling composition is mixed with the used material.

The process of the invention comprises the step of optionally increasing the temperature of the mixture of the used material and recycling composition obtained in steps (a) or (b). The temperature of the mixture may be increased to a temperature below the glass temperature of the polymer when a polymer is present in the used material. The temperature is generally maintained below 80° C., preferably below 70° C., more preferably below 60° C., even more preferably below 50° C. and most preferably below 40° C. A higher temperature may enable a faster cleaning time as contaminants are dissolved or detached more easily at elevated temperatures. In one embodiment, the temperature is maintained at room temperature so that no additional energy for heating the mixture is required, rendering the cleaning process of the invention more energy efficient.

In step (d) of the process of the invention, the recycling composition comprising the contaminants is separated from the used material. The liquid can be separated from the solid used material using conventional separation techniques well known to the skilled person, such as decanting or filtering. Preferably, the temperature of step (e) is decreased to below the temperature at which steps (a), (b), (c) or (d) is performed. When the process steps are conducted at room temperature the cooling step (e) does not have to be performed. In one embodiment, the temperature of the mixture is at most 70° C., preferably at most 60° C., more preferably at most 50° C., even more preferably at most 40° C., even more preferably at most 30° C. and most preferably at most 25° C., and preferably at least 0° C., more preferably at least 5° C., even more preferably at least 10° C. and most preferably at least 15° C.

The processes of the invention can be combined as desired. The cleaning step may precede any of the above recycling processes to ensure that relatively clean used material is being used in any one of these processes. It is also contemplated that the delamination process for example provides a portion of paper and polymer, from which the additives can be removed using the corresponding processes of the invention. In some instances, the paper, polymer and/or metal material can be separated using conventional techniques such as mechanical recycling processes based on density differences of the materials for example. The result of such mechanical recycling is the separation of metal, polymer and paper or paper and a metal/polymer mixture, or metal and a paper/polymer mixture. These separated materials can subsequently be used in any one of the process of the invention suitable to work up the material and obtain recycled material with a higher economical value.

The invention is exemplified in the following Examples.

### EXAMPLES

### Example 1

### γ-Butyrolactam and ε-Caprolactam (Weight Ratio 1:1)

5 g of γ-butyrolactam (solid) was mixed with 5 g ε-caprolactam (solid). The mixture was heated to about 70° C. until the mixture turns into a liquid. Subsequently, the liquid mixture was cooled to room temperature. A pourable, transparent liquid was obtained.

Distillation of the resulting liquid resulted in a distillate which was as transparent and clear as the initial liquid. No solids were formed in the remaining liquid and distillate. The remaining liquid and the distillate have the same composition as was confirmed with FT-IR.

### Example 2

### γ-Butyrolactam and ε-Caprolactam (Weight Ratio 2:1)

10 g of γ-butyrolactam (solid) was mixed with 5 g ε-caprolactam (solid). The mixture was heated to about 70° C. until the mixture turns into a liquid. Subsequently, the liquid mixture was cooled to room temperature. A pourable, transparent liquid was obtained.

### Example 3

### γ-Butyrolactam, ε-Caprolactam and Salicylic Acid (Molar Ratio 1:1:1)

5 g of γ-butyrolactam (solid) was mixed with 6.6 g ε-caprolactam (solid). The mixture was heated to about 70° C. until the mixture turns into a liquid. To the liquid, 8.1 g of salicyclic acid (solid) was added. Subsequently, the liquid mixture was cooled to room temperature. A pourable, transparent liquid was obtained.

The resulting liquid remained liquid at −28° C.

Water was added to the liquid of Example 4, and the liquid remained transparent even at 30 wt % of water. Moreover, the resulting liquid with water content up to 5 wt % remained liquid at −28° C. The liquid with a water content of 30 wt % was solidified at −28° C.

### Example 4

### γ-Butyrolactam, ε-Caprolactam and Salicylic Acid (Molar Ratio 1:1:2)

5 g of γ-butyrolactam (solid) was mixed with 6.6 g ε-caprolactam (solid). The mixture was heated to about 70° C. until the mixture turns into a liquid. To the liquid, 16.2 g of salicyclic acid (solid) was added. Subsequently, the liquid mixture was cooled to room temperature. A pourable, transparent liquid was obtained.

The resulting liquid remained liquid at −28° C.

Water was added to the liquid of Example 5, and the liquid remained transparent even at 40 wt % of water. Moreover, the resulting liquid with water content up to 5 wt % remained liquid at −28° C. The liquid with a water content of 40 wt % was solidified at −28° C.

### Example 5

### γ-Butyrolactam, ε-Caprolactam and Salicylic Acid (Molar Ratio 1:1:1) Neutralized

A recycling composition of Example 4 was prepared. To this composition dimethyl ethanol amine (DMAE) was added until a pH of 7 was reached. A pourable, transparent liquid was obtained.

### Example 6

### γ-Butyrolactam, ε-Caprolactam and Salicylic Acid (Molar Ratio 1:1:1) Neutralized

A recycling composition of Example 4 was prepared. To this composition n-butyl diethanol amine was added until a pH of 7 was reached. A pourable, transparent liquid was obtained.

### Example 7

### γ-Butyrolactam, ε-Caprolactam and Salicylic Acid (Molar Ratio 1:1:2) Neutralized

A recycling composition of Example 5 was prepared. To this composition dimethyl ethanol amine (DMAE) was added until a pH of 7 was reached. A pourable, transparent liquid was obtained.

### Example 8

### γ-Butyrolactam, ε-Caprolactam and Salicylic Acid (Molar Ratio 1:1:2) Neutralized

A recycling composition of Example 5 was prepared. To this composition n-butyl diethanol amine was added until a pH of 7 was reached. A pourable, transparent liquid was obtained.

### Example 9

### ε-Caprolactam, Lactic Acid and Water (Weight Ratio 5:4:1)

4 g of lactic acid and 1 g of de-ionized water were mixed with 5 g ε-caprolactam (solid). The mixture was heated to about 70° C. until the mixture turns into a liquid. Subsequently, the liquid mixture was cooled to room temperature. A pourable, transparent liquid was obtained.

### Example 10

### ε-Caprolactam, Citric Acid and Water (Weight Ratio 5:4:1)

4 g of citric acid and 1 g of de-ionized water were mixed with 5 g ε-caprolactam (solid). The mixture was heated to about 70° C. until the mixture turns into a liquid. Subsequently, the liquid mixture was cooled to room temperature. A pourable, transparent liquid was obtained.

### Example 11

### ε-Caprolactam and Water (Weight Ratio 9:1)

0.5 g of de-ionized water were mixed with 5 g ε-caprolactam (solid). The mixture was heated to about 70° C. until the mixture turns into a liquid. Subsequently, the liquid mixture was cooled to room temperature. A pourable, transparent liquid was obtained.

### Example 12

### ε-Caprolactam and Water (Weight Ratio 8:2)

1 g of de-ionized water were mixed with 5 g ε-caprolactam (solid). The mixture was heated to about 70° C. until the mixture turns into a liquid. Subsequently, the liquid mixture was cooled to room temperature. A pourable, transparent liquid was obtained.

### Example 13

### ε-Caprolactam, Lactic Acid and NX-800 (Weight Ratio 5:4:1)

4 g of lactic acid and 1 g of NX 800 (diisobutyrate ester) were mixed with 5 g ε-Caprolactam (solid). The mixture was heated to about 70° C. until the mixture turns into a liquid. Subsequently, the liquid mixture was cooled to room temperature. A pourable, transparent liquid was obtained.

### Example 14

### Coated Aluminium Can Cleaned with ε-Caprolactam, Lactic Acid and Water (Weight Ratio 5:4:1)

A piece (3 by 4 cm) of a coated can was cut out of a Zywiec® beer can. The coated can piece was added to a solvent system according to Example 9 in a glass beaker, which solvent covered the entire can piece. The glass beaker was put into an oven at a temperature of 190° C. After 30 minutes a clean piece of aluminum was obtained and a coloured solution.

### Example 15

### Coated Aluminium Can Cleaned with ε-Caprolactam, Citric Acid and Water (Weight Ratio 5:4:1)

A piece (3 by 4 cm) of a coated can was cut out of a Zywiec® beer can. The coated can piece was added to a solvent system according to Example 910 in a glass beaker, which solvent covered the entire can piece. The glass beaker was put into an oven at a temperature of 190° C. After 30 minutes a clean piece of aluminum was obtained and a coloured solution.

### Example 16

### Coated Aluminium Can Cleaned with ε-Caprolactam and Water (Weight Ratio 8:2)

A piece (3 by 4 cm) of a coated can was cut out of a Zywiec® beer can. The coated can piece was added to a solvent system according to Example 12 in a glass beaker, which solvent covered the entire can piece. The glass beaker was put into an oven at a temperature of 190° C. After 30 minutes a clean piece of aluminum was obtained and a coloured solution.

### Example 17

### Coated Aluminium Can Cleaned with ε-Caprolactam, Lactic Acid and Nx 800 (weight Ratio 5:4:1)

A piece (3 by 4 cm) of a coated can was cut out of a Zywiec® beer can. The coated can piece was added to a solvent system according to Example 13 in a glass beaker, which solvent covered the entire can piece. The glass beaker was put into an oven at a temperature of 190° C. After 30 minutes a clean piece of aluminum was obtained and a coloured solution.

### Examples 18 and 19

### PET with Label Cleaned with ε-Caprolactam and Water

10 pieces (1 by 2 cm) of a transparent PET with a printed paper label attached to the PET was cut out of a PET bottle. The PET pieces were added to a solvent system according to Example 11 in a glass beaker to which water was added to reach a 1 wt % ε-caprolactam solvent system. The solvent covered the PET pieces in its entirety. The glass beaker was put into an oven at a temperature of 200° C. After 60 minutes clean pieces of PET were obtained that do not stick. Additionally, pieces of the labels were obtained separate from the PET pieces, the label pieces were sticky (Example 18).

The same procedure was performed with a solvent system comprising 50 wt % ε-Caprolactam. After 60 minutes clean pieces of PET were obtained that do not stick. Additionally, pieces of the labels were obtained separate from the PET pieces, the label pieces were sticky (Example 19).

### Examples 20 and 21

### PET with Label Cleaned with ε-Caprolactam, Lactic Acid and Water

10 pieces (1 by 2 cm) of a transparent PET with a printed paper label attached to the PET was cut out of a PET bottle. The PET pieces were added to a solvent system according to Example 9 in a glass beaker to which water was added to reach a 1 wt % ε-caprolactam solvent system. The solvent covered the PET pieces in its entirety. The glass beaker was put into an oven at a temperature of 200° C. After 60 minutes clean pieces of PET were obtained that do not stick. Additionally, pieces of the labels were obtained separate from the PET pieces, the label pieces were sticky (Example 20).

The same procedure was performed with a solvent system comprising 50 wt % ε-caprolactam.

After 60 minutes clean pieces of PET were obtained that do not stick. Additionally, pieces of the labels were obtained separate from the PET pieces, the label pieces were sticky (Example 21).

### Example 22

### Brown PET Treated with ε-Caprolactam and Water

10 pieces (1 by 2 cm) of a brown PET was cut out of a brown PET beer bottle (Jelen®). The PET pieces were added to a solvent system according to Example 11 in a glass beaker. The solvent covered the PET pieces in its entirety. The glass beaker was put into an oven at a temperature of 200° C. After 30 minutes greyish pieces of PET were obtained and the solution was coloured (Example 22).

### Examples 23 and 24

### Colored PET Treated with ε-Caprolactam, Lactic Acid and Water (Weight Ratio 5:4:1)

30 pieces (1 by 1 cm) of a PET of different colours (transparent, green, red, blue) were obtained from a PET recycling plant, the PET pieces were without labels. The PET pieces were added to a solvent system according to Example 9 in a glass beaker. The solvent covered the PET pieces in its entirety. The glass beaker was put into an oven at a temperature of 200° C. After 30 minutes transparent pieces of PET were obtained and the solution was coloured (Example 23).

The same procedure was performed with the same solvent system except that the PET pieces were kept at room temperature for 60 minutes. Transparent PET pieces were obtained and the solution was coloured (Example 24).

### Example 25

### Milka® Chocolate Wrapping Treated with ε-Caprolactam, Lactic Acid and Water (Weight Ratio 5:4:1)

A piece of 3 by 4 cm was cut out of a purple Milka® chocolate wrapping. The piece of wrapping was added to a solvent system according to Example 9 in a glass beaker, which solvent covered the entire piece. The glass beaker was put into an oven at a temperature of 190° C.

After 3 minutes a clean and fully discoloured piece of polymer and a coloured solution were obtained.

### Example 26

### Bonite® Coffee Wrapping Treated with ε-Caprolactam, Lactic Acid and Water (Weight Ratio 5:4:1)

A piece of 3 by 4 cm was cut out of a purple Bonite® coffee wrapping. The piece of wrapping was added to a solvent system according to Example 9 in a glass beaker, to which water was added to reach a 50 wt % ε-caprolactam solvent system. The solvent covered the coffee wrapping piece in its entirety. The glass beaker was put into an oven at a temperature of 190° C. After 20 minutes a clean and fully discoloured piece of polymer, a clean sheet of aluminium and a coloured solution were obtained. Complete delamination of the aluminium and polymer layers was achieved.

### Example 27

### Bonite® Coffee Wrapping Treated with ε-Caprolactam and Water (Weight Ratio 9:1)

A piece of 3 by 4 cm was cut out of a purple Bonite® coffee wrapping. The piece of wrapping was added to a solvent system according to Example 11 in a glass beaker, to which water was added to reach a 50 wt % ε-caprolactam solvent system. The solvent covered the coffee wrapping piece in its entirety. The glass beaker was put into an oven at a temperature of 190° C. After 20 minutes a clean and fully discoloured piece of polymer, a clean sheet of aluminium and a coloured solution were obtained. Complete delamination of the aluminium and polymer layers was achieved.

### Example 28

### Camel® Tobacco Wrapping Treated with ε-Caprolactam, Lactic Acid and Water (Weight Ratio 5:4:1)

A piece of 3 by 4 cm was cut out of a purple Camel® tobacco wrapping. The piece of wrapping was added to a solvent system according to Example 9 in a glass beaker. The solvent covered the tobacco wrapping piece in its entirety. The glass beaker was put into an oven at a temperature of 190° C. After 20 minutes a clean and fully discoloured piece of PET polymer, a clean and fully discoloured sheet of LDPE polymer and a coloured solution (containing aluminium particles) were obtained. Complete delamination of the PET and LDPE layers was achieved.

### Example 29

### Verkade® Cookies Wrapping Treated with γ-butyrolactam, ε-Caprolactam and Salicylic Acid (Molar Ratio 1:1:2)

A piece of 3 by 4 cm was cut out of a purple Verkade® cookies wrapping. The piece of wrapping was added to a solvent system according to Example 4 in a glass beaker, to which 20 wt % water was added. The solvent covered the cookies wrapping piece in its entirety. The glass beaker was put into an oven at a temperature of 200° C. After 30 minutes a clean and fully discoloured piece of PET polymer, a clean and fully discoloured white piece of PP polymer and a coloured (purple-brownish) solution were obtained. Complete delamination of the PET and PP layers was achieved.

### Example 30

### Polypropylene Treated with ε-Caprolactam, Lactic Acid and Water

A piece of polypropylene (PP) was added to a solvent system according to Example 9 in a glass beaker. The solvent covered the PP pieces in its entirety. The glass beaker was put into an oven at a temperature of 200° C. After 5 minutes the PP dissolved and a clear solution was obtained.

The solution was cooled to room temperature and the PP solidified.

### Example 31

### Coated Aluminium Can Cleaned with ε-Caprolactam, Lactic Acid and Water (Weight Ratio 5:4:1)

5 pieces (2 by 5 cm) of a coated can was cut out of a Grolsch® beer can. The coated can pieces were added to a solvent system according to Example 9 in a glass beaker, which solvent covered the entirety of the can pieces. The glass beaker was put into an oven at a temperature of 190° C. After 30 minutes clean pieces of aluminum were obtained and a coloured solution.

### Example 32

### Coated Aluminium Can Cleaned with ε-Caprolactam, Lactic Acid and Water (Weight Ratio 5:4:1)

5 pieces (2 by 5 cm) of a coated can was cut out of a Heineken® beer can. The coated can pieces were added to a solvent system according to Example 9 in a glass beaker, which solvent covered the entirety of the can pieces. The glass beaker was put into an oven at a temperature of 190° C. After 30 minutes clean pieces of aluminum were obtained and a coloured solution.

### Examples 33 and 34

### Coloured PET Treated with ε-Caprolactam and Water (3 wt % Caprolactam)

3 g ε-Caprolactam and 0.3 g potassium hydroxide were dissolved in 96.7 g of de-ionized water to form a washing solution. 30 pieces (1 by 1 cm) of a transparent, colorless PET were obtained from a PET recycling plant, the PET pieces were without labels and contained tackifier. The

PET pieces were added to a washing solution in a glass beaker. The solution covered the PET pieces in its entirety. The solution with PET pieces was stirred and heated to a temperature of 70° C. After 30 minutes clean (without tackifier) transparent pieces of PET were obtained and the solution was brownish (Example 33).

The clean PET pieces were washed with water, dried and subsequently put into an oven at a temperature of 220° C. for 20 minutes. The resulting PET did not contain black or dark brown spots, which is an indication of the absence of tackifier.

The same procedure was performed with the same washing solution except that the PET pieces were kept at room temperature for 30 minutes. Clean and transparent PET pieces were obtained and the solution was brownish (Example 34).

The clean PET pieces were washed with water, dried and subsequently put into an oven at a temperature of 220° C. for 20 minutes. The resulting PET did not contain black or dark brown spots, which is an indication of the absence of tackifier.

### Examples 35

### Coloured PET Treated with ε-Caprolactam and Water (Weight Ratio 9:1)

30 pieces (1 by 1 cm) of a PET of different colours (transparent, green, red, blue) were obtained from a PET recycling plant, the PET pieces were without labels. The PET pieces were added to a solvent system according to Example 10 in a glass beaker. The solvent covered the PET pieces in its entirety. The glass beaker was put into an oven at a temperature of 200° C. for 60 minutes and shaken frequently. Upon cooling of the solvent system, a greyish powder of PET was obtained, which was filtered and dried. DSC and IR confirmed that the PET is similar to the PET in the initial PET pieces. The resulting filtrate was brownish and was subsequently filtered over active carbon powder to obtain a transparent, colourless solvent (Example 35).

### Examples 36

### Printed Cardboard Treated with ε-Caprolactam and Water (Weight Ratio 9:1)

30 pieces (1 by 1 cm) of a printed cardboard (with black ink) were added to a solvent system according to Example 10 in a glass beaker. The solvent covered the cardboard pieces in its entirety. The glass beaker was put into an oven at a temperature of 200° C. for 60 minutes and shaken frequently. Upon cooling of the solvent system, a white slurry was obtained. The resulting filtrate was greyish and was subsequently filtered over active carbon powder to obtain a transparent, colourless solvent. The white slurry was filtered and dried in an oven to obtain a greyish solid of cellulose fibers (Example 36).

1. A recycling composition comprising a lactam and/or a eutectic composition comprising a lactam and a eutecting agent.

2. The recycling composition according to claim 1, wherein the lactam is selected from the group consisting of 2-azetidinone, g-butyrolactam, 2-piperidinone and e-caprolactam.

3. The recycling Recycling composition according to claim 1, wherein the lactam is e-caprolactam.

4. The recycling composition according to claim 1 further comprising used polymer.

5. The recycling composition according to claim 1 further comprising additives from used polymer.

6-8. (canceled)

9. A process for recycling of used polymer comprising the steps of:
(a) contacting the used polymer with the recycling composition according to claim 1;
(b) optionally shredding the used polymer before, during and/or after step (a);
(c) optionally increasing the temperature of the mixture; and
(d) separating the recycling composition comprising at least part of the additives present in the used polymer from the used polymer; and (e) cooling the recycling composition and/or the used polymer before, during and/or after step (d).

10. A process for delaminating at least one polymer layer from a laminated substrate comprising the steps of:
(a) contacting the laminated substrate with the recycling composition according to claim 1;
(b) optionally shredding the laminated substrate before, during and/or after step (a);
(c) optionally increasing the temperature of the mixture;
(d) separating the at least one polymer layer from the substrate;
(e) optionally separating the recycling composition comprising at least part the polymer and/or the additives present in the laminated substrate from the substrate; and
(f) cooling the recycling composition and/or the substrate before, during and/or after step (d).

11. A process for separating a first used polymer and a second used polymer comprising the steps of:
(a) contacting the first and second used polymers with the recycling composition according to claim 1;
(b) optionally shredding the first and/or second used polymer before, during and/or after step (a);
(c) optionally increasing the temperature of the mixture;
(d) separating the recycling composition comprising at least part of the additives present in the first and/or second used polymers from the used polymers; and
(e) cooling the recycling composition and/or the first and/or second used polymer before, during and/or after step (d) to below the highest glass temperature of the first or second used polymer.

12. A process for removing the coating from a coated substrate comprising the steps of:
(a) contacting the coated substrate with the recycling composition according to claim 1;
(b) optionally shredding the coated substrate before, during and/or after step (a);
(c) optionally increasing the temperature of the mixture or the coated substrate; and
(d) separating the cured coating composition from the substrate.

13. A process for recycling of used paper comprising the steps of:
(a) contacting the used paper with the recycling composition according to claim 1;
(b) optionally shredding the used paper before, during and/or after step (a);
(c) optionally increasing the temperature of the mixture;
(d) separating the recycling composition comprising at least part of the additives present in the used paper from the used cellulose fibers; and
(e) cooling the recycling composition and/or the used paper before, during and/or after step (d).

14. A process for cleaning of contaminated used material comprising the steps of:
(a) contacting the contaminated used material with the recycling composition according to claim 1 at a temperature below 80° C.;
(b) optionally shredding the contaminated used material before, during and/or after step (a);
(c) optionally increasing the temperature of the mixture while maintaining the temperature below 80° C.;
(d) separating the recycling composition comprising at least part of the contaminants present in the contaminated used material from the used material; and
(e) optionally cooling the recycling composition and/or the used material before, during and/or after step (d).

15. The process according to claim 13, wherein the temperature of the recycling composition and/or the mixture in step (a) is room temperature.

16. The recycling composition according to claim 1, wherein the lactam comprises g-caprolactam and e-caprolactam.

17. The recycling composition according to claim 1, wherein the eutectic composition comprises g-caprolactam and e-caprolactam and a eutecting agent.

18. The recycling composition according to claim 1, wherein the eutecting agent comprises a hydrogen-bond donor, an electron pair donor, hydrogen-bond acceptor, an electron pair acceptor or a metal salt.

19. The recycling composition according to claim 1, wherein the eutecting agent is selected from the group consisting of cyclic acids, aliphatic acids, cyclic acid anhydrides, aliphatic acid anhydrides, amines, amides, imides and alcohols.

20. The recycling composition according to claim 1, wherein the eutecting agent is present in an amount of 10 wt % to 99 wt % based on the total weight of the eutectic composition.

21. The recycling composition according to claim 1, wherein the molar ratio between lactam and the eutecting agent is between 0.01 and 100.

22. The recycling composition according to claim 16, wherein the molar ratio between lactam and the eutecting agent is between 0.01 and 100.

23. The recycling composition according to claim 1 further comprising one or more of water, a second eutecting agent, a solvent, or a hydroxide salt.
